(19) United States
(12) Patent Application Publication
(10) Pub. No.: US 2024/0412045 A1
(43) Pub. Date: Dec. 12, 2024

(54) LARGE TENSOR TILING

(71) Applicant: Microsoft Technology Licensing, LLC, Redmond, WA (US)

(72) Inventors: Yaron Baruch SHAPIRO, Petach Tikva (IL); Khalil Abdul-Hamid WATTAD, Jatt (IL); Evgeny ROYZEN, Qiryat Ono (IL); Asaf LEVY, Hod Hasharon (IL)

(21) Appl. No.: 18/331,734

(22) Filed: Jun. 8, 2023

(51) Int. Cl. G06N 3/0464

(52) U.S. Cl. CPC G06N 3/0464

(57) ABSTRACT

Techniques for performing large tensor tiling (LTT) in hardware are enabled. LTT divides a large tensor (e.g., of unsupported size) into overlapping tiles (e.g., having supported tensor size(s)). A tensor may be processed processing the tiles. The output of each processed tile is stored, for example, in a systolic array considering the tile's placement in the large tensor. The output of all processed tiles is identical to the output of processing the large tensor. Tiles may be processed by reusing data overlapping boundaries shared with other tiles. In some examples, overlapping data may be reused (e.g., written once) or partly reused (e.g., written twice). Tiling large tensors with boundary duplication supports dynamic adaptation to a wide variety of tensor sizes, avoids re-reading duplicated data, and avoids reorganizing hardware for large tiles, which reduces power consumption and area, reduces complexity, and increases processing efficiency.

### BACKGROUND

A convolutional neural network (CNN) is a type of artificial neural network with various applications, including the analysis of images. CNNs implement at least one convolution and a mathematical operation. CNNs commonly convolve data tensors (e.g., image data) with weight tensors. Data tensors that are processed by one or more layers in CNNs may be different sizes.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Techniques for large tensor tiling (LTT) are disclosed herein that accommodate convolution of input tensors of varying sizes. LTT divides a large input tensor into smaller tiles with at least some of the smaller tiles being overlapping or crossover tiles with duplicated or otherwise reused edges. Adjacent tiles are considered “overlapping” when one or both tiles have a row/column of data of the other tile added (“duplicated”) at an edge at which the tiles meet (a “shared edge”). A tensor is processed (e.g., convolved) by processing the tiles into which the tensor is divided. The output of each processed tile is stored, for example, in a systolic array, taking into account the placement of the tile in the large tensor. The output of all processed tiles is identical to the output of processing the large tensor. Tiles are processed by reusing data in overlapping boundaries shared with other tiles. In some aspects, overlapping data may be reused (e.g., written once) or partly reused (e.g., written twice). Tiling large tensors with boundary duplication supports dynamic adaptation to a wide variety of tensor sizes, avoids re-reading duplicated data, and avoids reorganizing hardware for large tiles, which reduces power consumption and area, reduces complexity, and increases processing efficiency.

In aspects, a computing system includes a neural processing unit (NPU) that includes a systolic array and a data router. The systolic array includes a scalable array of interconnected processing elements (PEs). Each PE has an associated PE data memory configured to store at least a portion of an input tensor. The data router is configured to perform tensor tiling of an input tensor by determining or receiving an indication how to split the input tensor into a plurality of tiles based on the array of interconnected PEs and dimensions of the input tensor; and splitting the input tensor into the plurality of tiles, including a first tile and a second tile overlapping a shared edge, by routing the input tensor data to the PE data memories that store the plurality of tiles. Tiles may be processed (e.g., convolved) using data that overlaps the tile boundaries. Depending on the configuration of the array of interconnected PEs and/or routing/storage of tile data, the overlapping data at shared tile boundaries may be stored once and reused or may be duplicated, e.g., stored in multiple PE data memories. For example, a 16×16×4 tensor may be split into four 9×9×4 overlapping tensors. The overlapping nature of the tensors may result in reuse or duplication of stored tensor tile data.

In aspects, an input handler is configured to provide the indication to the data router. Each PE may be associated with a PE convolution engine (PE processing logic) configured to perform a convolution on a respective portion of a tile stored in the associated PE data memory. A systolic controller is configured to control the systolic array, with this control pipelined throughout the PEs, to perform the convolution on the respective portions of one or more tiles stored in the PE data memory based on the split and routing. The PE convolution engine is configured to perform the convolution on respective portions of multiple tiles stored in the associated PE data memory by reusing data in the associated PE data memory overlapping the shared edge. In some examples, the input tensor may be routed to the PE data memories that store the plurality of tiles, including the first and second tiles, with data overlapping the shared edge written once or duplicated in a first PE data memory associated with a first PE and in a second PE data memory associated with a second PE. In some examples, the tiles may be transposed in the PE data memories by storing tile rows as columns in the PE data memories. Each PE may be associated with a PE weight (e.g., convolution filter) memory. Weights may be routed to the PE weight memories based on the routing of the input tensor to store the plurality of tiles in the PE data memories. The data router may be a hardware-implemented algorithm. The systolic array may include a scalable array of interconnected PEs.

Further features and advantages of the embodiments, as well as the structure and operation of various embodiments, are described in detail below with reference to the accompanying drawings. It is noted that the claimed subject matter is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments and, together with the description, further serve to explain the principles of the embodiments and to enable a person skilled in the pertinent art to make and use the embodiments.

FIG. 1A shows a block diagram of an example computing system for large tensor tiling in hardware, in accordance with an example embodiment.

FIG. 1B shows an enlargement of a tensor in the tensor package shown in FIG. 1A, in accordance with an example embodiment.

FIG. 1C shows an enlargement of the overlapping tensor tiles shown in FIG. 1A, in accordance with an example embodiment.

FIG. 2 shows a block diagram of an example system for large tensor tiling in hardware, in accordance with an example embodiment.

FIG. 3 shows a block diagram of an example of hardware-implemented routing to perform large tensor tiling in a systolic array, in accordance with an embodiment.

FIG. 4 shows a block diagram of an example of performing large tensor tiling by routing tensor packages in a systolic array, in accordance with an embodiment.

FIG. 5A shows a flowchart of a process for implementing large tensor tiling in hardware, in accordance with an embodiment.

FIG. 5B shows a flowchart of a process for performing operations on large tensors by performing the operations on tensor tiles, according to an embodiment.

FIG. 6 shows a block diagram of an example computer system in which embodiments may be implemented.

The subject matter of the present application will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION

### I. Introduction

The following detailed description discloses numerous example embodiments. The scope of the present patent application is not limited to the disclosed embodiments, but also encompasses combinations of the disclosed embodiments, as well as modifications to the disclosed embodiments. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Example Embodiments

A convolutional neural network (CNN) is a type of artificial neural network with various applications, including the analysis of images. CNNs implement at least one convolution and a mathematical operation. CNNs commonly convolve data tensors (e.g., image data) with weight tensors. A large number of data tensors, which may be referred to as “channels,” and are each a fraction (image section) of an input image, are convolved with hundreds or thousands of “weights” of the weight tensors. The weights are filters, and by convolving them with the tensors, a desired result is achieved, such as a statistical labeling of the object(s) in the given input image.

Input data tensors may be stored/addressed in memory (e.g., static random access memory (SRAM)) in a particular format, such as NHWC format, indicating a batch size N, a height H, a width W, and a number of channels C, where data bytes are ordered by HW coordinates channel by channel C (e.g., bytes 1, 2, 3, 4, etc. for HW coordinate 0,0 for channel 0 to x, then bytes 1, 2, 3, 4, etc. for HW coordinate 0,1 for channel 0 to x, etc.).

Data tensors that are processed by one or more layers in CNNs may be different sizes. Supporting a wide variety of tensor sizes, from small to large, may impact power, area, efficiency, and complexity. A large tensor may be a tensor that is larger than an M×N matrix of a systolic array. For example, a systolic array may include a matrix with four columns and four rows of processing elements (PEs) (e.g., also known as clusters), where each PE has PE data memory that is two bytes wide. Each memory block may be “infinitely deep,” meaning memory depth per PE is not an issue, such that channel count is not an issue. This systolic array would fit an 8×8×4 tensor (e.g., a tensor that is 8 bytes High, 8 bytes Wide, and 4 Channels deep). However, this systolic array would not fit a 16×16×4 tensor, which would be a “large tensor” relative to the systolic array (e.g., PE matrix). The definition of a “large tensor” may be fluid if/when the matrix/memory sizes in a systolic array are scalable.

Regarding convolving two tensors (e.g., a weight tensor and a data tensor), a visual representation of the mathematical concept is sliding the weight over the data. In one example, the weight tensor may be a 3×3 tensor while the data tensor may be a 16×16 tensor. For each step of the convolution, the 3×3 weight tensor “slides over” the data tensor to a new position. Each step of the convolution is a 3×3 matrix multiplication of the weight tensor at its current position relative to a 3×3 portion of the data tensor. For positions/steps where the 3×3 weight doesn't fully overlap a 3×3 portion of the 16×16 data tensor, the data tensor is padded using zeroes (0), so that each pixel of the weight ‘interacts” with a counterpart from the data tensor at each position/step. This convolution relationship is something to be aware of when dealing with large tensors, e.g., the way the edges of the data tensor are convolved with the weight, including the use of padding. Note that the 3×3 tile size is provided for the purposes of illustration. In further embodiments, larger sized tiles may be used, including 4×4 tiles, 5×5 tiles, etc.

To process (e.g., convolve) a 16×16×4 tensor in a smaller systolic array, such as a matrix of PEs comprising 4 columns, 4 rows, where each PE memory cell is two (2) bytes wide, the data tensor may be split/fractured into smaller fractions referred to as tiles. Tensor tiles may be square, rectangular, etc. For example, an equal division of height and width of a 16×16×4 tensor would yield four square 8×8×4 tensor tiles. A tiling algorithm that divides/splits the 16×16×4 tensor in half by width or height would yield two rectangular very 8×16×4 tensor tiles. Tiling may be symmetrical or asymmetrical.

Following an example of dividing a 16×16×4 large tensor into four 8×8×4 tensor tiles, the tiles may be stored in a 4×4 matrix with 2-byte wide PE data memories with unlimited depth. Tiles may be stored transposed, e.g., tile rows may be stored as columns. Channel 1 tiles 1-4 may be each be stored spread across row zero (0) of four PE data memories that forms an 8 byte column x 32 byte row array to store the four 8×8 tiles of channel one (1). Channel 2 tiles 1-4 may each be stored spread across row one (1) of four PE data memories that forms an 8 byte column x 32 byte row array to store the four 8×8 tiles of channel two (2). Channel 3 tiles 1-4 may be each be stored spread across row two (2) of four PE data memories that forms an 8 byte column x 32 byte row array to store the four 8×8 tiles of channel three (3). Channel 4 tiles 1-4 may each be stored spread across row three (3) of four PE data memories that forms an 8 byte column x 32 byte row array to store the four 8×8 tiles of channel four (4).

This tiling example works for convolving the tiles with a weight tensor measuring 1×1, but not for larger size weight tensors. The 16×16 input data tensor has 16 rows and 16 columns of data. The four 8×8 tiles do not have the continuous data of the whole 16×16 tensor. Sliding a weight larger than 1×1 (e.g., 3×3) over the 8×8 tiles fails to interact with the continuous data of the 16×16 tensor, meaning the convolution of the tiles with a filter larger than 1×1 would fail to be identical to convolution of the original input data.

While overlapping data may be re-read, e.g., while stalling an operation such as a convolution calculation to re-organize the hardware for the new tile, such a procedure would have high cost in terms of latency (e.g., due to repetitive operations in CNNs) and power consumption. Latency and redundant reads may be avoided.

Convolution engines in each PE/cluster may be configured to automatically pad a data tensor during convolution calculations. The zero data used for padding may not be stored in the cluster data memory, e.g., to conserve memory resources. Software may be unaware of hardware-implemented tensor tiling operations, other than making small convolution adjustments. So, zeros may be padded around each tile rather than the actual data in the original input tensor, resulting in inaccurate convolution data.

As such, methods, systems, and computer program products are provided for enabling large tensor tiling (LTT). LTT divides a large tensor (e.g., a tensor that may have an unsupported size) into tiles (e.g., having supported tensor sizes) using overlapping or crossover tiles with duplicated or otherwise reused edges. A tensor may be processed (e.g., convolved) by processing the tiles, and the output of each processed tile is stored, for example, in a systolic array considering the placement of the tile in the large tensor. The output of all processed tiles is identical to the output of processing the large tensor. Tiles may be processed by including duplications of boundary rows and columns with other tiles. In some examples, duplicated columns may be reused while duplicated rows may be partly reused (e.g., read once, written twice), or vice versa. Tiling large tensors with boundary duplication avoids re-reading duplicated data and reorganizing hardware for large tiles, which reduces power consumption and area, reduces complexity, and increases processing efficiency. For example, a 16×16×4 tensor may be split into four 9×9×4 overlapping tensors. The overlapping nature of the tensors may result in reuse or duplication of stored tensor tile data.

In aspects, a computing system may include a neural processing unit (NPU) that includes a systolic array and a data router. The systolic array includes a scalable array of interconnected processing elements (PEs). Each PE has an associated PE data memory configured to store at least a portion of an input tensor. The data router is configured to perform tensor tiling of an input tensor by determining how to split the input tensor into a plurality of tiles, including a first tile and a second tile sharing a first edge, based on the array of interconnected PEs and dimensions of the input tensor; and splitting the input tensor into the plurality of tiles by routing the input tensor to the PE data memories to store the plurality of tiles, including the first and second tiles with the first edge. By determining a split of an input tensor into tiles based on the array and input tensor dimensions, various tensor sizes may be accommodated by the array, and extra processing cycles and memory that would have to otherwise be used may be avoided. Tiles may be processed (e.g., convolved) using overlapping data from other tiles along one or more shared tile boundaries. Depending on the configuration of the array of interconnected PEs, the overlapping data at shared tile boundaries may be stored once and reused or may be duplicated, e.g., stored in multiple PE data memories.

In aspects, an input handler may be configured to provide the indication to the data router. Each PE may be associated with a PE convolution engine configured to perform a convolution on a respective portion of a tile stored in the associated PE data memory. A systolic controller may be configured to control each of the PE convolution engines to perform the convolution on the respective portion of a tile stored in the associated PE data memory based on the split. Convolution on tiles split from larger tensors avoids reorganizing hardware for large tiles. The PE convolution engine may be configured to perform the convolution on respective portions of multiple tiles stored in the associated PE data memory by reusing data in the associated PE data memory overlapping the first edge. The overlapping that reuses data enables accurate convolution results to be generated based on tiles that are portions of an input tensor, thereby enabling a same-sized hardware configuration for a systolic array to accommodate different sized input tensors. In some examples, the input tensor may be routed to the PE data memories to store the plurality of tiles, including the first and second tiles, with a first and/or second edge duplicated in a first PE data memory associated with a first PE and in a second PE data memory associated with a second PE. In some examples, the tiles may be transposed in the PE data memories by storing tile rows as columns in the PE data memories, or in additional memory present to store tile data (e.g., memory positioned at edges of the systolic array). Each PE may be associated with a PE weight (e.g., convolution filter) memory. Weights may be routed to the PE weight memories based on the routing of the input tensor to store the plurality of tiles in the PE data memories. The data router may be a hardware-implemented algorithm. The systolic array may include a scalable array of interconnected PEs, capable of accommodating various input tensor sizes at various systolic array sizes.

Embodiments have numerous advantages. For instance, the entire process of tensor tiling in a systolic array is transparent to software, and thus reduces software dependency. Instead, the CNN hardware is used to tile large/oversized tensors according to the tensor size, channel count, and the PE matrix of PE data memories.

Furthermore, accesses to SRAM are reduced by tensor tiling techniques disclosed herein, which reduces overall latency and power consumption. Tiling of tensors is instead performed in hardware in the local area of the systolic array, and thus repeated SRAM accesses are avoided.

Still further, embodiments enable fast adaptive capabilities. The hardware-implemented algorithms described herein enable the processing of tensors of various tensor sizes/channel counts, including oversized tensors.

Furthermore, low power is consumed in part because embodiments are orchestrated by a relatively low number of logic elements, and because this logic is near the relatively smaller memory cells internal to the CNN, the costly data transportation that characterizes SRAM access by a CPU which is located relatively “far away” on the PCB is reduced.

Still further, the flexibility of embodiments enable future formats and operations in the constantly evolving field of machine language (ML)/artificial intelligence (AI).

Even further, embodiments enable parallelism of hardware acceleration and traditional CPU computation. In the event of extreme network loads, the CNN hardware can process part of the tensor space while the CPU can provide assistance.

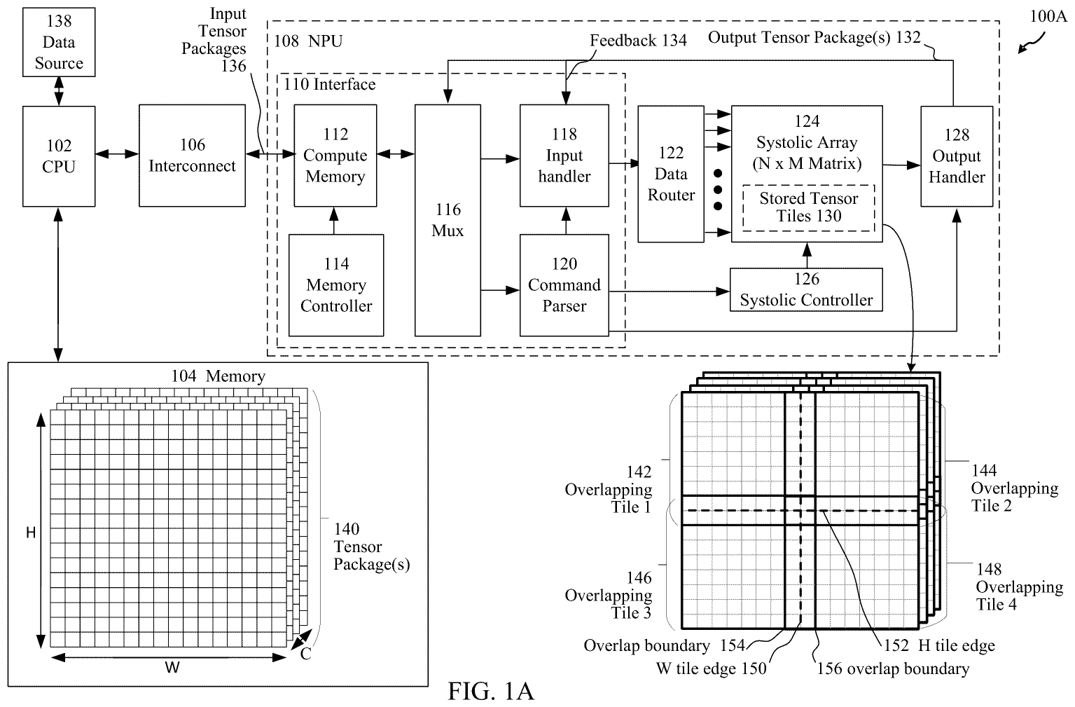

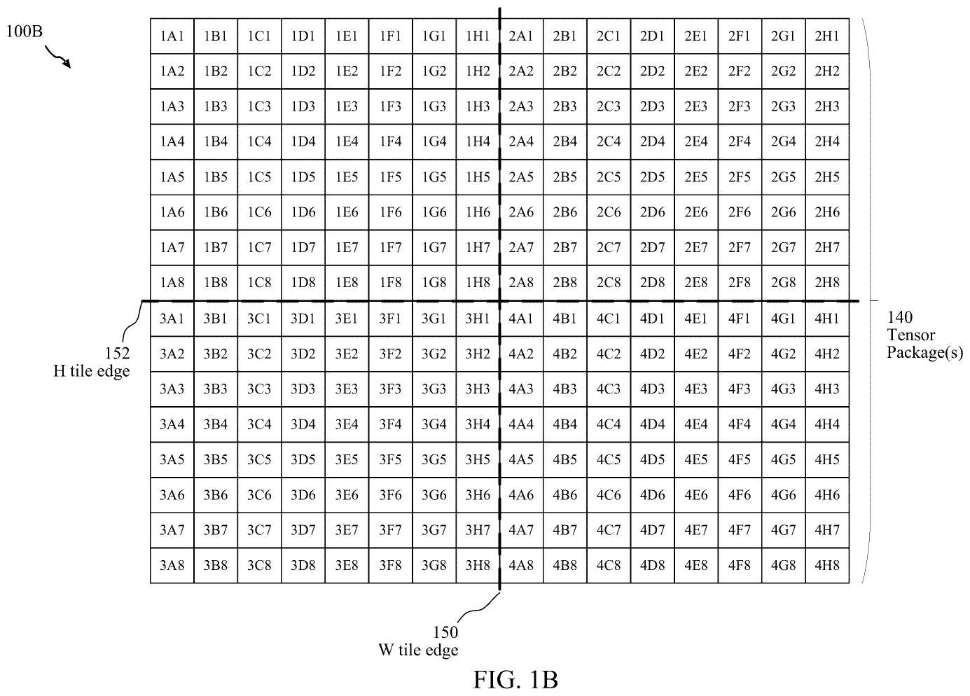

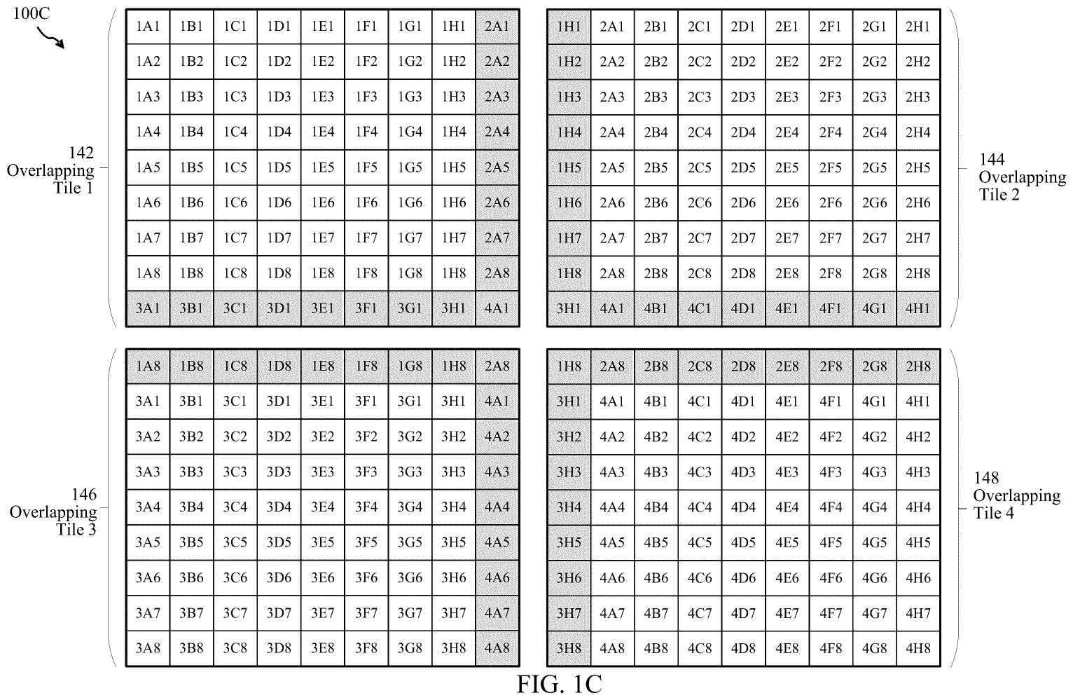

These and further embodiments may be configured in various ways. For instance, FIG. 1A shows a block diagram of an example computing system 100 for large tensor tiling in hardware, in accordance with an example embodiment. As shown in FIG. 1A, example computing system 100 includes central processing unit (CPU) 102, a memory device 104, an interconnect 106, and a neural processing unit (NPU) 108. NPU 108 includes an interface 110, an input handler 118, a command parser 120, a data router 122, a systolic array 124, a systolic controller 126, and an output handler 128. Interface 110 includes a compute memory 112, a memory controller 114, and a multiplexer (Mux) 116. Note that not all these components need be present in all embodiments. In some examples, computing system 100 may be implemented as a system on a chip (SoC) or in other manners. These components of example computing system 100 are described in further detail as follows.

CPU 102 may comprise any type of processor, microcontroller, a microprocessor, signal processor, application specific integrated circuit (ASIC), and/or other physical hardware processor circuit) for performing computing tasks, such as program execution, signal coding, data processing, input/output processing, power control, and/or other functions. CPU 102 is configured to execute program code, such as an operating system and/or application programs (e.g., machine learning (ML), artificial intelligence (AI)), which may invoke use of one or more NPUs (e.g., as described herein), for example, to process images. CPU 102 may perform operations, e.g., based on execution of executable code, which may include one or more steps in processes/methods disclosed herein.

CPU 102 may issue one or more commands (e.g., via interconnect 106) directed to one or more components in NPU 108. CPU may initiate a transaction with (e.g., external) memory 104 and/or with data source 138. For example, CPU 102 may read one or more tensor packages stored in memory 104 and/or receive one or more tensor packages from data source 138, e.g., for processing by NPU 108. CPU 108 may indicate to NPU 108 that one or tensor packages should be tiled. For example, CPU 108 may indicate to NPU 108 that tensor package(s) 140 read from memory 104 should be tiled for storage and/or one or more operations, such as convolution.

Memory 104 may be any type of data storage technology, e.g., static random access memory (SRAM), synchronous dynamic random access memory (SDRAM), etc. Memory 104 may store any type of information, e.g., data, weights, for operations performed by CPU 102 and/or NPU 108. Memory 104 may store any number of tensor packages. As shown in FIG. 1A, memory 104 stores a tensor package(s) 140. For example, tensor package(s) 140 may include a four channel tensor measuring 16×16. Tensor package(s) 140 and other tensors may be in the same or different formats (e.g., NHWC).

Interconnect 106 may provide a communication bus between CPU 102 and NPU 108. Interface 110 provides an interface for NPU 108 with CPU 102 (through interconnect 106). CPU 102 may transfer tensor packages (e.g., tensor package(s) 140) with a tensor descriptor to compute memory 112 in interface 110 in NPU 108. The tensor descriptor may indicate one or more operations, such as tensor tiling, convolution, concatenation, etc. Tensor package(s) 140 may be transferred, for example, byte-by-byte (e.g., as tensor vectors in NHWC format) through interconnect 106.

Neural processing unit (NPU) 108 may be a specialized processing unit (e.g., a microprocessor) configured to accelerate performance of machine learning (ML) tasks, e.g., for neural network applications. NPU 108 may be implemented to free up CPU 102 and/or a graphical processing unit (GPU) (not shown) to perform other (e.g., non-ML) computing tasks. For example, NPU 108 may improve the performance of a CNN that processes images. NPU 108 may receive input data in the form of tensors, perform operations including tensor tiling, convolutions, and generate a result. Data in a tensor may be organized in a multi-dimensional array of vectors.

Compute memory 112 may receive input tensor package(s) 140 with one or more tensor descriptors via interconnect 106. For example, compute memory 112 may receive and store tensor package(s) 140. First, second, and/or third tensor packages may be received, for example, byte-by-byte (e.g., as tensor vectors in NHWC format) through interconnect 106. Compute memory 112 may store tensor package(s) 140, tensor descriptors, commands, etc., for example, based on control provided by memory controller 114. Compute memory 112 may read out tensor package(s) 140, tensor descriptors, commands, etc., for example, based on control provided by memory controller 114.

Memory controller 114 may control configuration and/or operation of compute memory 112. Memory controller 114 may comprise, for example, one or more state machines. Memory controller 114 may control input, storage, and output for compute memory 112, for example, by controlling data valid signals based on determinations when data (e.g., tensor vectors) in interconnect 106 are ready to be read/written. When data is read, the data is read consecutively from a known memory address, and logic of input handler 118 is the owner of any “format awareness.” Memory controller 114 may determine the format of tensor packages and use it to determine storage locations in compute memory 112, e.g., in the same or different format. Memory controller 114 may load commands and/or tensor descriptors in compute memory 112 into command parser 120 (e.g., via mux 116).

Multiplexer (Mux) 116 may provide data information (e.g., tensor packages) to input handler 118 and control information (e.g., commands, tensor descriptors) to command parser 120. Multiplexer may be controlled, for example, by memory controller 114, command parser 120, and/or input handler 118.

Command parser 120 may parse commands generated by CPU 102. Command parser 120 may decode commands and distribute parsed commands to one or more NPU components, such as input handler 118 and/or systolic controller 126. Parsed commands provided to input handler 118 and/or systolic controller 126 may include, for example, systolic array (e.g., matrix) size, tensor package size, tensor package format, data validity indicator, operation description (e.g., tensor tiling, concatenation(s), convolution(s), iteration(s)), etc.

Input handler 118 may receive tensor data (e.g., tensor package(s) 140) from compute memory 112 via mux 116. Input handler 118 may receive instructions for handling tensor data from command parser 120. Input handler 118 may execute a hardware-implemented algorithm that operates according to the tensor descriptor(s) associated with the tensor package(s) 140 parsed by command parser 120. Input handler 118 may generate an indication (e.g., a set of commands or parameters) for data router 122. For example, input handler 118 may associate a routing indication with each tensor package 140 consistent with one or more operations (e.g., tiling, convolution, concatenation) indicated in one or more tensor descriptors provided by CPU 102.

Data router 122 may receive tensor package(s) 140. Data router 122 may determine or may receive one or more indications of how to route tensor package(s) 140 to accomplish the operations (e.g., tiling, convolution, concatenation). Data router 122 may perform a hardware-implemented algorithm, e.g., according to the data and routing indication(s) received from input handler 118. Data router 122 may perform a tiling operation for tensor package(s) 140 by routing data in tensor package(s) 140 to PE data memories in systolic array 124. Data router 122 may route tensor data from tensor package(s) 140 according to a tiling determination or an indication from input handler 118 consistent with an operation (e.g., tiling, convolution, concatenation of tensors) commanded by CPU 102. Data router 122 may perform tiling by routing tensor data in tensor package(s) 140 to a set of PE data memories. For convolution operations, data router 122 may (e.g., also) route weights to PE weight memories based on the routing of tensor package(s) to PE data memories (e.g., to accomplish tiling).

Systolic controller 126 may control (re)configuration, input, storage, and output for systolic array 124, for example, by controlling data valid signals to PE data memories (e.g., or PE weight memories) based on determinations when data router 122 is configured and ready for tensor data passed through input handler 118 to be read/written into PE data memories (e.g., or PE weight memories). For example, systolic controller 126 may (re)configure systolic array 124 to a specified N×M matrix of PEs with specified sizes of PE data memories and weight memories. Systolic controller 126 may receive parsed commands from command parser 120, for example, to control systolic array data valid, write enable, address, and/or other signals consistent with performing LTT by routing of tensor package(s) 140 performed by data router 122.

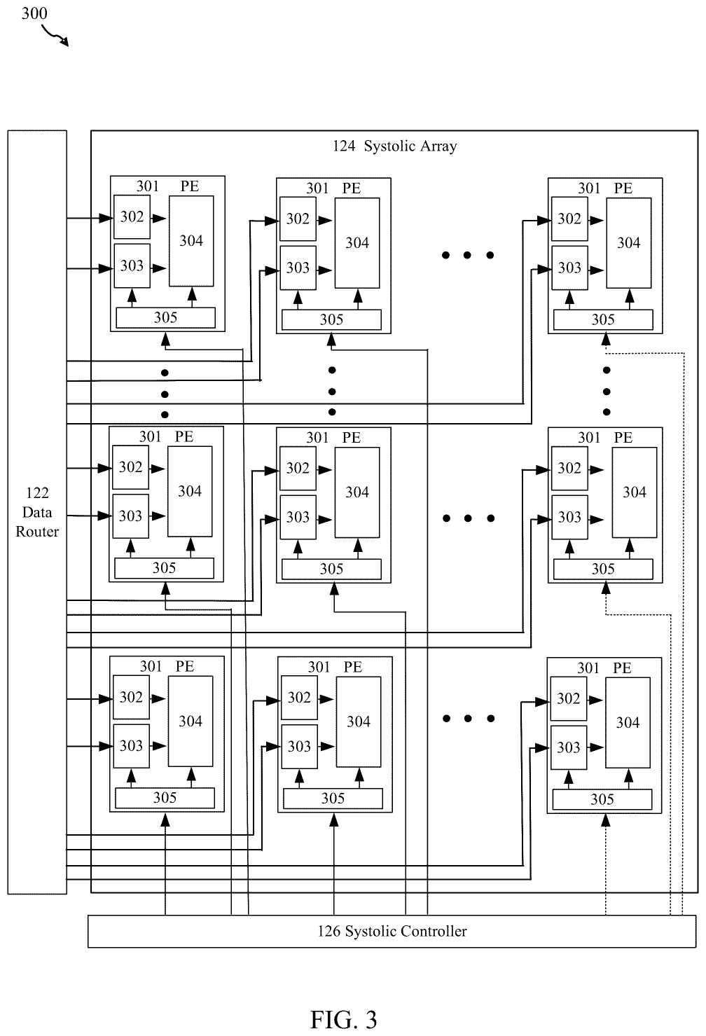

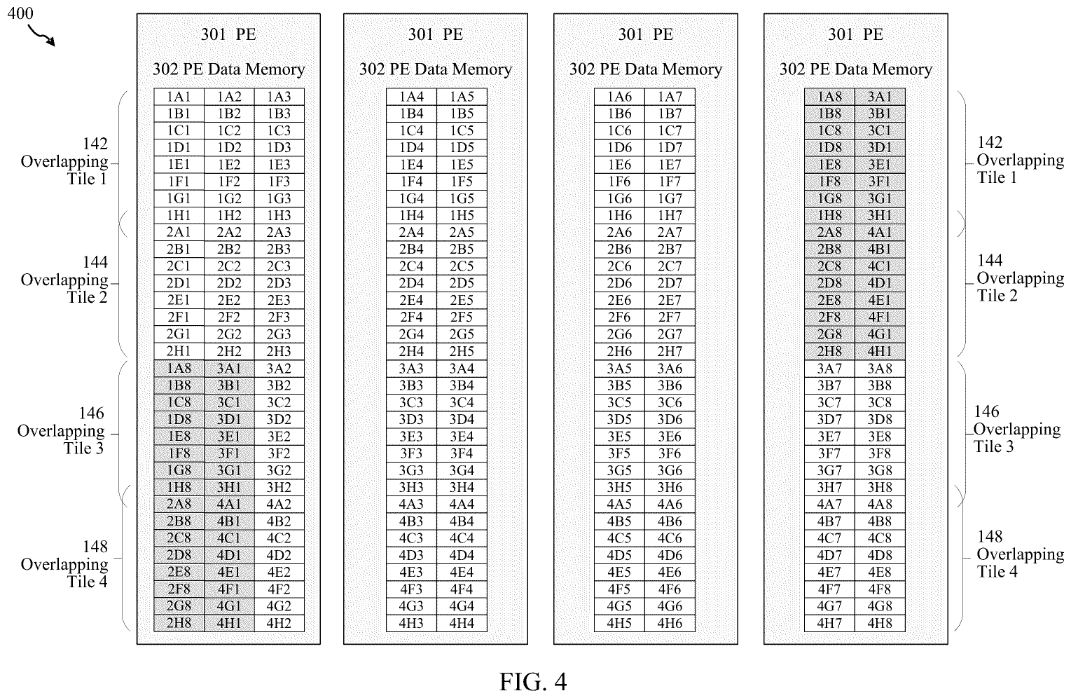

Systolic array 124 may comprise a (e.g., dynamically reconfigurable) N×M array (e.g., matrix) of processing elements (PEs). Systolic array 124 may be variable (e.g., a selectable sized array or matrix), for example, to support scalability (e.g., handling a wider variety of ML tasks). PEs may be referred to as cells or clusters. Each PE may include, for example, a PE data memory, a weight memory, processing logic, and a control interface. FIGS. 3 and 4 show additional examples of systolic array 124 and tiling performed by routing of tensors in tensor package(s) 140 in systolic array 124. Data router 122 and input handler 118 may control write operations into systolic array 124. Systolic controller 126 and/or output handler 128 may control read operations out of systolic array 124 to output handler 128. As shown in FIG. 1A, tensor package(s) 140 may be written to systolic array 124 based on controls provided by data router 122 and systolic controller 126. Tensor package(s) 140 may be written to systolic array 124 based on routing to PE data memories. Tensor package(s) 140, represented as stored tensor tiles 130, are tiled as stored in PE data memories in systolic array 124.

Output handler 128 may receive computational results (e.g., computed tensors) generated by compute layer comprising systolic controller 126 and systolic array 124. The computed tensors may be or may include partial sums (PSums). Output handler 128 may perform operations on the received computed tensors to generate output tensor package(s) 132, which may be output (e.g., returned as results to CPU 102) via mux 116 or fed back 134 to systolic array 124 through input handler 118 (e.g., for further processing, such as iterative or additional operations).

As shown in FIG. 1A, e.g., by data source 138 and feedback 134 of output tensor package(s) 132 from output handler 128 to mux 116, example system 100 can perform tiling by routing of data arriving from outside memory 104 (e.g., data source 138, such as a video streaming service) and/or from an intermediate result (e.g., stored tensor tiles 130 or fed back output tensor package(s) 132, such as iterative or additional operations). For example, since NPU 108 processes a CNN outside CPU 102, tiling by routing may be performed for tensors that are post convolution, avoiding a costly (e.g., resource intensive) roundtrip of tensors back to memory 104. For example, stored tensor tiles 130, output tensor package(s) 132 and/or input tensor package(s) 136 may be tiled by routing.

In the example shown in FIG. 1A, tensor package 140 may be 16×16×4. Data router 122 may determine or may receive an indication (e.g., from input handler 118), to split the 16×16×4 tensor package into four equal 8×8×4 tiles. The 16×16×4 tensor may be split along W tile edge 150 and H tile edge 152, creating the four 8×8×4 tiles. In implementation, the tiles may overlap their shared edges. The overlapping of shared edges, where a column or row of data is duplicated, supports dynamic adaptation to a wide variety of tensor sizes, avoids re-reading duplicated data, and avoids reorganizing hardware for large tiles, which reduces power consumption and area, reduces complexity, and increases processing efficiency. For example, overlapping tiles may be 9×9×4, as shown for illustration in FIG. 1A. Furthermore, tiles 1 and 3 have an overlap boundary 156 while tiles 2 and 4 have an overlap boundary 154. The overlapping tensor tiles are shown as overlapping tile 1 142, overlapping tile 2 144, overlapping tile 3 146, and overlapping tile 4 148. The determination or indication about how to split tensor package(s) 140 may be based on the size of the N×M systolic array 124 and/or other parameters.

FIG. 1B shows an enlargement of the tensor package shown in FIG. 1A, in accordance with an example embodiment. Example 100B shows tensor package 140 as a 16×16 tensor. For clarity, example 100B shows only the first of the four tensor channels in a 16×16×4 tensor package. Each channel may be split as shown in example 100B. H tile edge 152 and W tile edge 150 are shown to identify how the 16×16×4 tensor is split/fractured in this example. H tile edge 152 and W tile edge 150 identify the shared tile edges. For comparison with example overlapping tiles shown in FIG. 1C and example stored overlapping tiles in FIG. 4, each tensor data element (e.g., byte) in the 16×16 tensor is pre-labeled with a three digit identifier comprising a number and letter combination. The first number represents the tile number, e.g., 1, 2, 3, 4. The letter represents the column of data in the tile, e.g., A, B, C, D, E, F, G, H. The last number represents the row of data in the tile. For example, 1A1 indicates tile 1, column A, row 1. Other examples may split tensor package 140 into more or fewer tiles that are equal, unequal, symmetric, or asymmetric.

FIG. 1C shows an enlargement of the overlapping tensor tiles shown in FIG. 1A, in accordance with an example embodiment. Example 100C shows the four 8×8 tiles identified in example 100B implemented as overlapping 9×9 tiles. For clarity, example 100C shows only the first of the four tensor channels. Each channel may be split as shown in example 100C. Overlapping tile 1 142 includes the 8×8 tile with columns 1A-1H as well as an overlap of portions of tiles 2, 3, and 4 over H tile edge 152 and W tile edge 150, as shown by data identified by shading and labels 2A1-8, 3A1-3H1, and 4A1 along the right and bottom edges of overlapping tile 1 142. Overlapping tile 2 144 includes the 8×8 tile with columns 2A-2H as well as an overlap of portions of tiles 1, 3, and 4 over H tile edge 152 and W tile edge 150, as shown by shading and data identified by labels 1H1-8, 3H1, and 4A1-4H1 along the left and bottom edges of overlapping tile 2 144. Overlapping tile 3 146 includes the 8×8 tile with columns 3A-3H as well as an overlap of portions of tiles 1, 2, and 4 over H tile edge 152 and W tile edge 150, as shown by shading and data identified by labels 1A8-1H8, 2A8, and 4A1-8 along the top and right edges of overlapping tile 3 146. Overlapping tile 4 148 includes the 8×8 tile with columns 4A-4H as well as an overlap of portions of tiles 1, 2, and 3 over H tile edge 152 and W tile edge 150, as shown by shading and data identified by labels 1H8, 2A8-2H8, and 3H1-8 along the top and left edges of overlapping tile 4 148. Data router 122 may route tensor package(s) 140 into PE data memories in systolic array 124 as overlapping tiles 1-4 142-148. The overlapping data may be written once and reused during operations (e.g., convolution) or may be duplicated (e.g., written to multiple PE data memories), for example, depending on the routing.

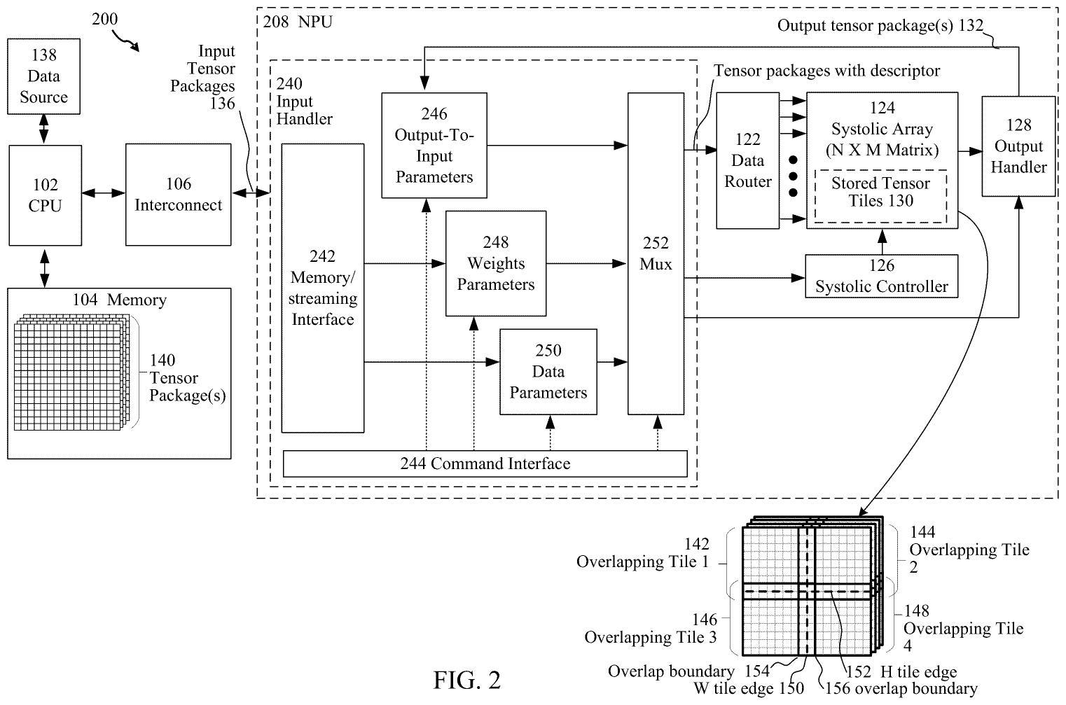

FIG. 2 shows a block diagram of an example system for large tensor tiling in hardware, in accordance with an example embodiment. FIG. 2 shows an example similar to that of FIG. 1A with a different front-end or interface. As shown in FIG. 2, example computing system 200 includes central processing unit (CPU) 102, memory device 104, interconnect 106, and NPU 208. NPU 208 includes an input handler 240, a memory/streaming interface 242, a data router 122, systolic array 124, systolic controller 126, and output handler 128. Input handler 240 may comprise a command interface 244, and a multiplexer (Mux) 252. Note that not all these components need be present in all embodiments. In some examples, computing system 200 may be implemented as a system on a chip (SoC) or otherwise. These components of example computing system 200 are described in further detail as follows.

As described above, CPU 102 may comprise any type of processor, microcontroller, a microprocessor, signal processor, application specific integrated circuit (ASIC), and/or other physical hardware processor circuit) for performing computing tasks, such as program execution, signal coding, data processing, input/output processing, power control, and/or other functions. CPU 102 is configured to execute program code, such as an operating system and/or application programs (e.g., machine learning (ML), artificial intelligence (AI)), which may invoke use of one or more NPUs (e.g., as described herein), for example, to process images. CPU 102 may perform operations, e.g., based on execution of executable code, which may include one or more steps in processes/methods disclosed herein.

CPU 102 may issue one or more commands (e.g., via interconnect 106) directed to one or more components in NPU 108. CPU may initiate a transaction with (e.g., external) memory 104 and/or with data source 138. For example, CPU 102 may read one or more tensor packages stored in memory 104 and/or receive one or more tensor packages from data source 138, e.g., for processing by NPU 108. CPU 108 may indicate to NPU 108 that multiple tensor packages should be tiled. For example, CPU 108 may indicate to NPU 108 that tensor package(s) 140 read from memory 104 should be tiled.

Memory 104 may be any type of data storage technology, e.g., static random access memory (SRAM), synchronous dynamic random access memory (SDRAM), etc. Memory 104 may store any type of information, e.g., data, weights, for operations performed by CPU 102 and/or NPU 108. Memory 104 may store any number of tensor packages. As shown in FIG. 1A, memory 104 stores tensor package(s) 140. Tensors in tensor package(s) 140 may be in the same or different formats (e.g., NHWC).

Interconnect 106 may provide a communication bus between CPU 102 and NPU 108. CPU 102 may read first, second and/or third tensor packages. CPU 102 may transfer tensor package(s) 140 with a tensor descriptor to compute memory 112 in NPU 108. The tensor descriptor may indicate one or more operations, such as tiling, convolution, concatenation of tensors, etc. Tensor package(s) 140 may be transferred, for example, byte-by-byte (e.g., as tensor vectors in NHWC format) through interconnect 106.

Neural processing unit (NPU) 208 may be a specialized processing unit (e.g., a microprocessor) configured to accelerate performance of machine learning (ML) tasks, e.g., for neural network applications. NPU 108 may be implemented to free up CPU 102 and/or a graphical processing unit (GPU) (not shown) to perform other (e.g., non-ML) computing tasks. For example, NPU 208 may improve the performance of a CNN that processes images. NPU 208 may receive input data in the form of tensors, perform operations (e.g., tiling, convolution, concatenation) on the input tensors, and generate a result. Data in a tensor may be organized in a multi-dimensional array of vectors.

Memory/streaming interface 242 may receive input tensor packages 136 with one or more tensor descriptors via interconnect 106. For example, memory/streaming interface 242 may receive and store (e.g., buffer) tensor package(s) 140. Tensor package(s) 140 may be received, for example, byte-by-byte (e.g., as tensor vectors in NHWC format) through interconnect 106. Memory/streaming interface 242 may store (e.g., buffer) tensor package(s) 140, associated tensor descriptors, commands, etc. Memory/streaming interface 242 may determine the format of tensor packages and use it to determine storage locations in memory, e.g., in the same or different format. Memory/streaming interface 242 may provide tensor package(s) 140, associated tensor descriptors, commands, etc. to input handler 240, command interface 242, and/or mux 252. Memory/streaming interface 242 may be (re)configurable.

Command interface 244 may parse commands generated by CPU 102, which may include tensor descriptors and/or other instructions/commands (e.g., tiling, convolution, concatenation operation). Command interface 244 may decode commands and distribute parsed commands to input handler 240 (e.g., to enable/activate output-to-input parameters 246, weights parameters 248, and/or data parameters 250), mux 252, data router 122, systolic controller 126, and/or output handler 128. Parsed commands provided to input handler 240, mux 252, data router 122, systolic controller 126, and/or output handler 128 may include, for example, systolic array (e.g., matrix) size, tensor package size, tensor package format, data validity indicator, operation description (e.g., tiling, concatenation(s), convolution(s), iteration(s)), etc.

Input handler 240 may transfer input data (e.g., tensor packages) received through memory/streaming interface 242 via interconnect 106 and/or fed back from output handler 128 to data router 122 and generate routing-storage instructions (e.g., for an operation, such as tiling, convolution, concatenation) (e.g., as metadata parameters) for the data router 122 to route the data into systolic array 124 (e.g., to perform LTT by routing). Input handler 240 may execute a hardware-implemented algorithm that operates according to the tensor descriptor(s) associated with tensor packages and/or commands parsed by command parser 120. Input handler 240 may generate an indication (e.g., a set of commands or parameters) for data router 122. For example, input handler 240 may associate a routing indication with each tensor package 140 consistent with one or more operations (e.g., tiling, convolution, concatenation) indicated in one or more tensor descriptors provided by CPU 102.

For example, input handler 240 may process one or more tensor descriptors received with tensor packages to generate routing-storage parameters (e.g., in metadata). Input handler 240 may generate the routing-storage parameters based on input tensor packages 136, output tensor package(s) 132, tensor descriptors, CPU commands, and/or internal operation information indicated by command interface 244. Input handler 240 may associate the routing-storage parameters with the tensor packages that are provided to data router 122 and/or systolic array 124 via mux 252. The routing-storage parameters may be provided with data (e.g., tensor packages) to data router 122 and/or systolic array 124.

The routing-storage instructions (e.g., parameters in metadata) may indicate to data router 122 where to route the data (e.g., tensor packages) inside systolic array 124. The routing-storage instructions may include, for example, output-to-input parameters 246, weights parameters 248, and data parameters 250. Output-to-input parameters 246 may indicate how output tensor package(s) 132 are to be routed by data router 122 into PE data memories in systolic array 124 (e.g., as stored tensor tiles 130) for a next operation by NPU 208. Weights parameters 248 may indicate how weights (e.g., filters) are to be routed by data router 122 into PE weight memories in systolic array 124 for a next operation by NPU 208. Data parameters 250 may indicate how input tensor packages 136 are to be routed by data router 122 into PE data memories in systolic array 124 (e.g., as stored tensor tiles 130) for a next operation by NPU 208.

Output-to-input parameters 246, weights parameters 248, and data parameters 250 generated by input handler 240 may include, for example, an address inside a PE data memory in systolic array 124 in which to store the incoming data byte, an indication of which systolic array 144 matrix column is being written (e.g., if data parameters are active) or an indication of which systolic array 144 matrix row to write (e.g., if output-to-input parameters are active), and/or a write enable vector. Output-to-input parameters 246, weights parameters 248, and data parameters 250 may be duplicated, for example, so that each PE data memory that is being written to (e.g., to store routed tensor packages) may store the routed data at the same place in a data memory. The data may be different in each PE data memory since a different segment of the input data is routed to each PE data memory.

Multiplexer (Mux) 116 may provide data (e.g., tensor packages), routing, and storage information to data router 122, operational control information (e.g., parsed commands, tensor descriptors) to systolic controller 126 and output handler 128. Multiplexer may be controlled, for example, by command interface 244 and/or input handler 240.

Data router 122 may receive tensor packages and one or more indications of how to route the tensor packages to accomplish the one or more operations (e.g., tiling, convolution, concatenation). Data router 122 may receive tensor data (e.g., tensor package(s) 140) from memory/streaming interface 242 via mux 252. Data router 122 may receive routing-storage instructions for handling tensor data from input handler 240, e.g., in the form of output-to-input parameters 246, weights parameters 248, and data parameters 250. Data router 122 may perform a hardware-implemented algorithm according to the data and routing indication(s) received from input handler 240. Data router 122 may perform a tiling operation by routing data to PE data memories in systolic array 124. Data router 122 may route tensor data from each of the tensor package(s) 140 according to routing indications from input handler 240 (e.g., output-to-input parameters 246, weights parameters 248, and data parameters 250) consistent with an operation (e.g., tiling of tensor package(s) 140) commanded by CPU 102. Data router 122 may perform tiling by routing tensor package(s) 140 to a set of PE data memories. For convolution operations, data router 122 may (e.g., also) route weights to PE weight memories based on routing of tensor package(s) 140 to PE data memories (e.g., according to weights parameters 248), thereby keeping the weights associated with their associated tiled tensor data for accurate performance of convolution.

Systolic controller 126 may control (re)configuration, storage, and output for systolic array 124, for example, by controlling data valid signals to PE data memories (e.g., or PE weight memories) based on determinations when data router 122 is configured and ready for tensor data passed through input handler 240 to be read/written into PE data memories (e.g., or PE weight memories). For example, systolic controller 126 may (re)configure systolic array 124 to a specified N×M matrix of PEs with specified sizes of PE data memories and weight memories. Systolic controller 126 may receive parsed commands from command interface 244, for example, to control systolic array data valid, write enable, and/or other signals consistent with performing LTT by routing of tensor package(s) 140 performed by data router 122.

Systolic array 124 may comprise a (e.g., dynamically reconfigurable) N×M array (e.g., matrix) of processing elements (PEs). Systolic array 124 may be variable (e.g., a selectable sized array or matrix), for example, to support scalability (e.g., handling a wider variety of ML tasks). PEs may be referred to as cells or clusters. Each PE may include, for example, a PE data memory, a weight memory, processing logic, and a control interface. FIGS. 3 and 4 show additional examples of systolic array 124 and tiling by routing of tensors in systolic array 124. Data router 122 and systolic controller 126 may control write operations into systolic array 124. Systolic controller 126 and/or output handler 128 may control read operations out of systolic array 124 to output handler 128. As shown in FIG. 2, tensor package(s) 140 may be written to systolic array 124 based on controls provided by data router 122. Tensors in tensor package(s) 140 may be tiled by routing to PE data memories in systolic array 124. Tensor package(s) 140, represented as stored tensor tiles 130, are overlapping tiles in PE data memories in systolic array 124, shown as overlapping tiles 1-4 142-148. Note that in an embodiment, each PE may have its own associated PE data memory, while in another embodiment, a cluster of PEs may have associated data memory accessible by the PEs of the cluster.

Output handler 128 may receive computational results (e.g., computed tensors) generated by compute layer comprising systolic controller 126 and systolic array 124. The computed tensors may be or may include partial sums (PSums). Output handler 128 may perform operations on the received computed tensors to generate output tensor package(s) 132, which may be output (e.g., returned as results to CPU 102) via memory/streaming interface 242 or fed back to systolic array 124 through input handler 240 (e.g., for further processing, such as iterative or additional operations) as output tensor package(s) 132.

As shown in FIG. 2, e.g., by data source 138 and output tensor package(s) 132 from output handler 128 to input handler 240, example computing system 200 can perform tiling by routing data arriving from outside memory 104 (e.g., data source 138, such as a video streaming service) and/or from an intermediate result (e.g., stored tensor tiles 130 or fed back output tensor package(s) 132, such as iterative or additional operations). For example, since NPU 108 processes a CNN outside CPU 102, tiling by routing may be performed for tensors that are post convolution, avoiding a costly (e.g., resource intensive) roundtrip of tensors back to memory 104. For example, stored tensor tiles 130, output tensor package(s) 132 and/or input tensor package(s) 136 may be tiled by routing.

In the example shown in FIG. 2, tensor package 140 may be 16×16×4. Data router 122 may determine or may receive an indication (e.g., from input handler 118), to split the 16×16×4 tensor package into four equal 8×8×4 tiles. The 16×16×4 tensor may be split along W tile edge 150 and H tile edge 152, creating the four 8×8×4 tiles. In implementation, the tiles may overlap their shared edges. For example, overlapping tiles may be 9×9×4. Tiles 1 and 3 may have overlap boundary 156 while tiles 2 and 4 may have overlap boundary 154. The overlapping tensor tiles are shown as overlapping tile 1 142, overlapping tile 2 144, overlapping tile 3 146, and overlapping tile 4 148. The determination or indication about how to split tensor package(s) 140 may be based on the size of the N×M systolic array 124 and/or other parameters.

In embodiments, systolic array 124 may be implemented in various ways. For instance, FIG. 3 shows a block diagram of an example 300 of hardware-implemented routing in systolic array 124 to perform large tensor tiling, in accordance with an embodiment. Example 300 shows systolic array 124, data router 122 and systolic controller 126 shown in FIGS. 1 and 2.

Systolic array 124 may comprise a (e.g., dynamically reconfigurable) N×M array (e.g., matrix) of processing elements (PEs) 301. Systolic array 124 may be variable (e.g., a selectable sized array or matrix), for example, to support scalability (e.g., handling a wider variety of ML tasks). PEs 301 may be referred to as cells or clusters. Systolic array 124 (e.g., matrix) may comprise, for example, several hundred (scalable) PEs 301. The (re)configurable matrix or array of PEs 301 may be a cascaded pipeline of PEs. The cascaded PEs may successively pass data from one PE to another PE without involvement by CPU 102. For example, data (e.g., stored tensors) from the first row (e.g., bottom row) of PEs 301 may percolate upwards to the upper row of PEs 301. The structure of systolic array 124 is scalable to a desired height and width. Internal memories (e.g., PE data memory 302, PE weight memory 303) may be selected/(re)configured according to applications, operations, etc.

Each PE 301 may include, for example, a PE data memory 302, a PE weight memory 303, PE processing logic 304 (also referred to herein as “convolution engine” or “PE convolution engine”), and a PE control interface 305. Note that as described elsewhere herein, PE data memory 302 may be associated with an individual PE or with a cluster of PEs (e.g., PEs in a sequence). PE data memory 302 may store tensors, which may be sourced from input tensor packages 136 and/or output tensor package(s) 132. PE weight memory 303 may store weights for convolutions with tensors in PE data memory 302. PE processing logic 304 may perform operations, such as convolution operations using weight data in PE weight memory 303 and tensor data in PE data memory 302. PE control interface 305 may control a configuration of PE 301 and/or operations performed by PE 301.

In preparation for one or more data processing operations using systolic array 124, data (e.g., tensors) may be copied into configured/selected PE data memories 302 (e.g., and weights may be copied to configured/selected PE weight memories 303) according to the algorithm implemented by the input handler 118/240 based on the operation(s) indicated by CPU 102. For example, a tensor package may be stored in PE data memories 301 according to one or more operation(s), such as tiling, convolution, concatenation, etc.

As shown in FIG. 3, data router 122 may control write operations into systolic array 124. Systolic controller 126 and/or output handler 128 (e.g., or command parser 120, command interface 244) may control read operations out of systolic array 124 to output handler 128. FIG. 3 shows example data lines from data router 122 to PE data memories 302 and PE weight memories 303. FIG. 3 also shows example control signal lines from systolic controller to PE control interfaces 305.

Data router 122 may receive tensor packages and one or more indications (e.g., tensor descriptors, routing-storage parameters) indicating how to route the tensor packages (e.g., and weights) to accomplish the one or more operations (e.g., tiling, convolution, concatenation). In some examples, data router 122 may determine routing to perform the one or more operations. Data router 122 may perform a hardware-implemented algorithm according to the data and routing determination or indication(s) received from an input handler (e.g., as shown in FIG. 1 or 2). For example, data router 122 may perform an oversized/large tensor tiling operation by routing data to PE data memories 302 in systolic array 124. Data router 122 may route tensor data from a tensor package according to a routing determination/indication, which may be selected to be consistent with an operation commanded by CPU 102. Data router 122 may perform tiling by routing tensors in a tensor package to a set of PE data memories 302. For convolution operations (e.g., following tiling), data router 122 may (e.g., also) route weights to PE weight memories 303 based on routing of tensor packages to PE data memories.

Systolic controller 126 may control (re)configuration, input, storage, and output for systolic array 124, for example, by controlling data valid signals to PE data memories 302 (e.g., or PE weight memories 303) based on determinations when data router 122 is configured and ready for tensor data passed through the input handler to be read/written into PE data memories 302 (e.g., or PE weight memories 303). For example, systolic controller 126 may (re)configure systolic array 124 to a specified N×M matrix of PEs 301 with specified sizes of PE data memories 302 and PE weight memories 303. Systolic controller 126 may receive parsed commands from a command parser, a common interface or directly from CPU 102 to control systolic array data valid, write enable, and/or other control signals to PEs 301 consistent with an operation, thereby activating processing by PEs 301. Large tensor tiling results from input handler 240 and data router 122 placement of the tensor data in PE data memories 303 in systolic array 124.

Continuing with the example provided in FIGS. 1A-1C and FIG. 2, systolic controller 126 may configure a matrix of PEs (e.g., a 4×4 matrix of PEs) in systolic array 124 to store overlapping tiles 1-4 (e.g., 9×9×4 overlapping tiles 1-4) 142-148 as stored tensor package 130. Data router 122 may route tensor data in tensor package 140 (e.g., 16×16×4 tensor) to the configured matrix (e.g., 4×4 matrix of PEs) to create overlapping tiles 1-4 (e.g., 9×9×4 overlapping tiles 1-4) 142-148 as stored tensor package 130. Systolic controller 126 may configure convolution engines (PE processing logic 304) in the configured matrix to perform convolution operations on overlapping tiles 1-4, generating output identical to performing the convolution on tensor package 140 as a whole.

FIG. 4 shows a block diagram of an example of performing large tensor tiling by routing of tensor packages in a systolic array using data memory of PE clusters as storage, in accordance with an embodiment. As shown in FIG. 4, example 400 shows an example of the first row (row 1) of a 4×4 matrix of PEs storing channel 1 of 9×9 overlapping tiles 1-4 142-148. Each of channels 2-4 of the 9×9 overlapping tiles 142-148 may be stored similarly in rows 2-4 of the 4×4 matrix of PEs.

FIG. 4 shows a simplified version of systolic array 124 shown in FIG. 3 to explain how channels of tensors in tensor packages may be tiled by routing in hardware (e.g., in data memory and received data in PEs. As shown in FIG. 4, PE data memory 302 in each PE 301 is shown replaced with a more detailed pseudo memory structure appropriate for the input tensors. The controls and data bus lines shown in FIG. 3 are removed for clarity.

As shown in FIG. 4, tensor package(s) 140 may be routed and stored in (e.g., written to) systolic array 124 based on routing provided by data router 122 and storage signals provided by systolic controller 126. Tensor package(s) 140, as shown in FIG. 4, represent stored tensor tiles 130 shown in FIGS. 1A and 2. Stored tensor tiles 130, as shown in FIG. 4, are tiled by routing the tensor packages into PE data memories 302 in systolic array 124 (or, in some cases, into additional memories located adjacent to border clusters of systolic array 124), which may be configured by systolic controller 126.

In the example shown in FIG. 4, each tensor channel is distributed among/across multiple PE data memories 302. In some examples, tensor channels may be completely (e.g., as a whole) stored in a respective PE data memory 302. In the example shown in FIG. 4, the LTT by routing operation may maintain the data format of the tensors. In some examples, an LTT by routing operation may alter the data format of the tensors. In the example shown in FIG. 4, tensor data in tiles may be transposed, e.g., where rows may be written as columns or vice versa. In some examples, tensor data in tiles may be written without transpose. Such transposition enables the proper alignment of data in the systolic array for subsequent convolution. Parallel routing of one or more tensor packages into data memory may be used for reduced time spent loading tensor data into PE data memories 302, while routing the tensor packages at different times may reduce hardware overhead needed for the routing (e.g., fewer routing data channels may be used).

The architecture of the PEs 301 in combination with (e.g., hardware-implemented) input handling/routing algorithms allow for a tensor tiling to take zero time, e.g., in the sense that tiling by routing is equivalent to a tensor fetch operation that also includes performance of a tensor tiling operation. With tiling performed by the equivalent of a fetch operation, the tiled tensor is already prepared for subsequent operations, such as convolution with weights routed to PE weight memories 303 based on the tiled tensor. Technical advantages of hardware tiling by routing include reduced CPU operations, reduced access to SRAM, reduced power consumption, faster tensor operations, etc.

Comparison of data labels in FIGS. 1B, 1C and 4 illustrate an example of the process of determining how to split an oversized/large tensor, splitting the tensor into tiles, and storing the tiles, which may be implemented in a single step, two steps, or more steps. For example, tiles may be created (e.g., the large tensor may be split) by the act of routing tensor data into PE data memories to create overlapping tiles. The example of tiling by routing to PE data memories 302 shown in FIG. 4 distributes each tile across four PE data memories 302. Other examples may distribute the tiles differently. For example, overlapping tile 1 142 is distributed across the top of the four data memories, then overlapping tile 2 144, then overlapping tile 3 146, and then overlapping tile 4 148 is distributed across the lower portion of the four PE data memories 302. Other examples may distribute tiles in other orders.

In the example shown in FIG. 4, data in tensor tiles is transposed, e.g., tensor tile rows shown in FIG. 1C are written as columns in PE data memories 302. It may be observed that horizontal overlapping data for tiles 1-4 are duplicated, as shown by shading, while vertical overlapping data are not duplicated (e.g., vertical data is continuous and reused during operations). The relationships between which overlapping data is duplicated and which overlapping data is not duplicated in PE data memories may vary by implementation. For example, transposing the tiled data and/or the orientation of PE data memories may affect which overlapping data is duplicated. In the routing example shown, overlapping data on the right edge of tile 1 (e.g., vertical/column data 2A1-2A8, 4A1) is not duplicated. Rather, it is continuous. This continuous overlapping data may be utilized during operations (e.g., convolutions) without duplicating the overlapping data. Overlapping data on the bottom edge of tile 1 (e.g., horizontal/row data 3A1-3H1) is duplicated, as highlighted by shading.

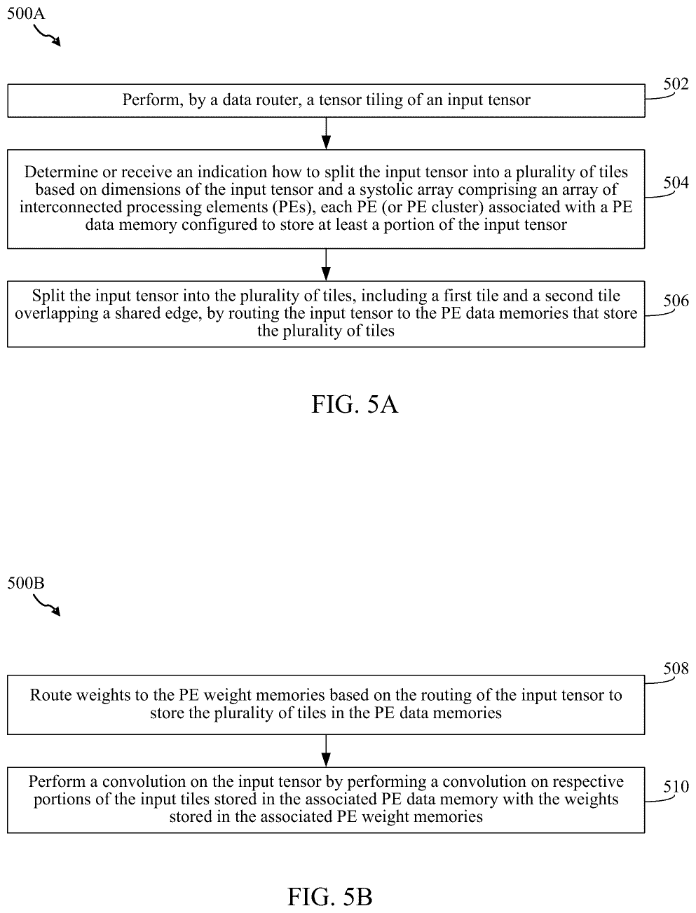

Embodiments described herein may operate in various ways. For instance, FIG. 5A shows a flowchart 500A of a process for implementing large tensor tiling in hardware, in accordance with an embodiment. Example computing systems 100 and 200, as shown by examples in FIGS. 1A-C, and 2-4, may operate according to flowchart 500A, e.g., in some embodiments. For example, example flowchart 500A may be implemented by data router 122, input handler 118, and/or systolic array 124. Various embodiments may implement one or more steps shown in FIG. 5A with additional and/or alternative steps. Further structural and operational embodiments will be apparent to persons skilled in the relevant art(s) based on the following description of FIG. 5A.

Flowchart 500A includes step 502. In step 502, a data router may perform a tensor tiling of an input tensor. For example, as shown in FIGS. 1A, 2 and 4, data router 122 may perform tensor tiling by routing tensor package(s) 140 into PE data memories in systolic array 124 for storage as stored tensor tiles 130.

In step 504, a determination may be made or an indication may be received indicating how to split the input tensor into a plurality of tiles based on dimensions of the input tensor and a systolic array comprising an array of interconnected processing elements (PEs), each PE (or PE cluster) associated with a PE data memory configured to store at least a portion of the input tensor. For example, as shown in FIGS. 1A-C, 2, 3, and 4, data router 122 may determine or may receive an indication from input handler 118 indicating how to split the 16×16×4 tensor shown in FIG. 1B based on the dimensions of the tensor and the array of PEs 301 with associated data memories 302 in systolic array 124.

In step 506, the input tensor may be split into the plurality of tiles, including a first tile and a second tile overlapping a shared edge, by routing the input tensor to the PE data memories that store the plurality of tiles. For example, as shown in FIGS. 1A-C, 2, 3, and 4, data router 122 may perform the split of the 16×16×4 tensor shown in FIG. 1B by H tile edge 152 and W tile edge 150 into overlapping tiles 1-4 142-148 shown in FIG. 1C by routing the tensor data into PE data memories 302 associated with PEs 301 as shown in FIG. 4, repeating the routing in each row of a 4×4 array of PEs for each of the four channels of the 16×16×4 tensor.

FIG. 5B shows a flowchart 500B of a process for performing operations on large tensors by performing the operations on tensor tiles, according to an embodiment. Example computing systems 100 and 200, as shown by examples in FIGS. 1A-1C, and 2-4, may operate according to flowchart 500B, e.g., in some embodiments. For example, example flowchart 500B may be implemented by CPU 102, compute memory 112, memory controller 114, input handler 118, data router 122, systolic array 124, systolic controller 126 shown in FIG. 1A or CPU 102, memory/streaming interface 242, command interface 244, input handler 240, data router 122, systolic array 124, and systolic controller 126 shown in FIG. 2. Various embodiments may implement one or more steps shown in FIG. 5B with additional and/or alternative steps. Further structural and operational embodiments will be apparent to persons skilled in the relevant art(s) based on the following description of FIG. 5B.

Flowchart 500B includes step 508. In step 508, weights may be routed to the PE weight memories based on the routing of the input tensor to store the plurality of tiles in the PE data memories. For example, as shown in FIGS. 1 and 2, CPU 102 may instruct/command performance of a convolution operation on tensor package(s) 140 stored as stored tensor tiles 130. Data router 122 may route weights to PE weight memories 303 associated with PEs 301 based on the routing of the input tensor package(s) 140 for storage as stored tensor tiles 130 in PE data memories 302, e.g., as shown by example in FIGS. 1B, 1C, and 4.

In step 510, a convolution operation may be performed on the input tensor by performing a convolution on respective portions of the input tiles stored in the associated PE data memory with the weights stored in the associated PE weight memories. For example, as shown in FIGS. 1 and 2, systolic controller 126 may (e.g., in accordance with a command from CPU 102) configure convolution engines (PE processing logic 304) associated with PEs 301 to perform a convolution on respective portions of the input tiles 1-4 142-148 stored in associated PE data memories 302 with the weights stored in associated PE weight memories 303.

### III. Example Computing Device Embodiments

As noted herein, the embodiments described, along with any circuits, components and/or subcomponents thereof, as well as the flowcharts/flow diagrams described herein, including portions thereof, and/or other embodiments, may be implemented in hardware, or hardware with any combination of software and/or firmware, including being implemented as computer program code (program instructions) configured to be executed in one or more processors and stored in a computer readable storage medium, or being implemented as hardware logic/electrical circuitry, such as being implemented together in a system-on-chip (SoC), a field programmable gate array (FPGA), and/or an application specific integrated circuit (ASIC). A SOC may include an integrated circuit chip that includes one or more of a processor (e.g., a microcontroller, microprocessor, digital signal processor (DSP), etc.), memory, one or more communication interfaces, and/or further circuits and/or embedded firmware to perform its functions.

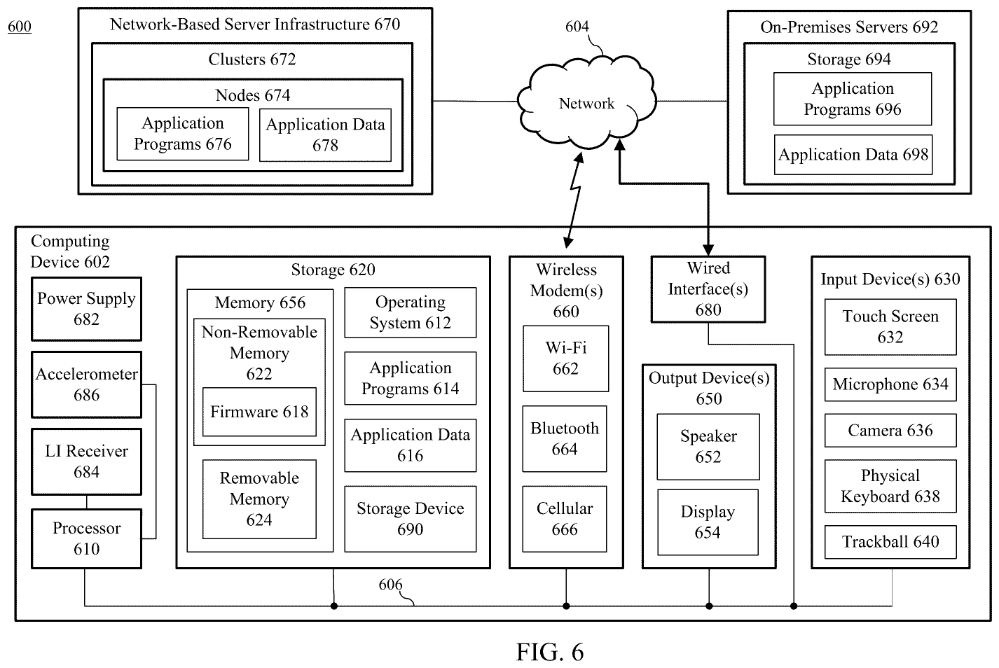

Embodiments disclosed herein may be implemented in one or more computing devices that may be mobile (a mobile device) and/or stationary (a stationary device) and may include any combination of the features of such mobile and stationary computing devices. Examples of computing devices in which embodiments may be implemented are described as follows with respect to FIG. 6. FIG. 6 shows a block diagram of an exemplary computing environment 600 that includes a computing device 602. Computing device 602 is an example of computing system 100 with NPU 108 shown in FIG. 1A and an example of computing system 200 with NPU 208 shown in FIG. 2, which may include one or more of the components of computing device 602. In some embodiments, computing device 602 is communicatively coupled with devices (not shown in FIG. 6) external to computing environment 600 via network 604. Network 604 comprises one or more networks such as local area networks (LANs), wide area networks (WANs), enterprise networks, the Internet, etc., and may include one or more wired and/or wireless portions. Network 604 may additionally or alternatively include a cellular network for cellular communications. Computing device 602 is described in detail as follows.

Computing device 602 can be any of a variety of types of computing devices. For example, computing device 602 may be a mobile computing device such as a handheld computer (e.g., a personal digital assistant (PDA)), a laptop computer, a tablet computer, a hybrid device, a notebook computer, a netbook, a mobile phone (e.g., a cell phone, a smart phone, a wearable computing device (e.g., a head-mounted augmented reality and/or virtual reality device including smart glasses, or other type of mobile computing device. Computing device 602 may alternatively be a stationary computing device such as a desktop computer, a personal computer (PC), a stationary server device, a minicomputer, a mainframe, a supercomputer, etc.

As shown in FIG. 6, computing device 602 includes a variety of hardware and software components, including a processor 610, a storage 620, one or more input devices 630, one or more output devices 650, one or more wireless modems 660, one or more wired interfaces 680, a power supply 682, a location information (LI) receiver 684, and an accelerometer 686. Storage 620 includes memory 656, which includes non-removable memory 622 and removable memory 624, and a storage device 690. Storage 620 also stores an operating system 612, application programs 614, and application data 616. Wireless modem(s) 660 include a Wi-Fi modem 662, a Bluetooth modem 664, and a cellular modem 666. Output device(s) 650 includes a speaker 652 and a display 654. Input device(s) 630 includes a touch screen 632, a microphone 634, a camera 636, a physical keyboard 638, and a trackball 640. Not all components of computing device 602 shown in FIG. 6 are present in all embodiments, additional components not shown may be present, and any combination of the components may be present in a particular embodiment. These components of computing device 602 are described as follows.

A single processor 610 (e.g., central processing unit (CPU), microcontroller, a microprocessor, signal processor, ASIC (application specific integrated circuit), and/or other physical hardware processor circuit) or multiple processors 610 may be present in computing device 602 for performing such tasks as program execution, signal coding, data processing, input/output processing, power control, and/or other functions. Processor 610 may be a single-core or multi-core processor, and each processor core may be single-threaded or multithreaded (to provide multiple threads of execution concurrently). Processor 610 is configured to execute program code stored in a computer readable medium, such as program code of operating system 612 and application programs 614 stored in storage 620. The program code is structured to cause processor 610 to perform operations, including the processes/methods disclosed herein. Operating system 612 controls the allocation and usage of the components of computing device 602 and provides support for one or more application programs 614 (also referred to as “applications” or “apps”). Application programs 614 may include common computing applications (e.g., e-mail applications, calendars, contact managers, web browsers, messaging applications), further computing applications (e.g., word processing applications, mapping applications, media player applications, productivity suite applications), one or more machine learning (ML) models, as well as applications related to the embodiments disclosed elsewhere herein.

Any component in computing device 602 can communicate with any other component according to function, although not all connections are shown for case of illustration. For instance, as shown in FIG. 6, bus 606 is a multiple signal line communication medium (e.g., conductive traces in silicon, metal traces along a motherboard, wires, etc.) that may be present to communicatively couple processor 610 to various other components of computing device 602, although in other embodiments, an alternative bus, further buses, and/or one or more individual signal lines may be present to communicatively couple components. Bus 606 represents one or more of any of several types of bus structures, including a memory bus or memory controller, a peripheral bus, an accelerated graphics port, and a processor or local bus using any of a variety of bus architectures.

Storage 620 is physical storage that includes one or both of memory 656 and storage device 690, which store operating system 612, application programs 614, and application data 616 according to any distribution. Non-removable memory 622 includes one or more of RAM (random access memory), ROM (read only memory), flash memory, a solid-state drive (SSD), a hard disk drive (e.g., a disk drive for reading from and writing to a hard disk), and/or other physical memory device type. Non-removable memory 622 may include main memory and may be separate from or fabricated in a same integrated circuit as processor 610. As shown in FIG. 6, non-removable memory 622 stores firmware 618, which may be present to provide low-level control of hardware. Examples of firmware 618 include BIOS (Basic Input/Output System, such as on personal computers) and boot firmware (e.g., on smart phones). Removable memory 624 may be inserted into a receptacle of or otherwise coupled to computing device 602 and can be removed by a user from computing device 602. Removable memory 624 can include any suitable removable memory device type, including an SD (Secure Digital) card, a Subscriber Identity Module (SIM) card, which is well known in GSM (Global System for Mobile Communications) communication systems, and/or other removable physical memory device type. One or more of storage device 690 may be present that are internal and/or external to a housing of computing device 602 and may or may not be removable. Examples of storage device 690 include a hard disk drive, a SSD, a thumb drive (e.g., a USB (Universal Serial Bus) flash drive), or other physical storage device.

One or more programs may be stored in storage 620. Such programs include operating system 612, one or more application programs 614, and other program modules and program data. Examples of such application programs may include, for example, computer program logic (e.g., computer program code/instructions) for implementing one or more of CPU 102 utilization of NPU 108/208.

Storage 620 also stores data used and/or generated by operating system 612 and application programs 614 as application data 616. Examples of application data 616 include web pages, text, images, tables, sound files, video data, and other data, which may also be sent to and/or received from one or more network servers or other devices via one or more wired or wireless networks. Storage 620 can be used to store further data including a subscriber identifier, such as an International Mobile Subscriber Identity (IMSI), and an equipment identifier, such as an International Mobile Equipment Identifier (IMEI). Such identifiers can be transmitted to a network server to identify users and equipment.

A user may enter commands and information into computing device 602 through one or more input devices 630 and may receive information from computing device 602 through one or more output devices 650. Input device(s) 630 may include one or more of touch screen 632, microphone 634, camera 636, physical keyboard 638 and/or trackball 640 and output device(s) 650 may include one or more of speaker 652 and display 654. Each of input device(s) 630 and output device(s) 650 may be integral to computing device 602 (e.g., built into a housing of computing device 602) or external to computing device 602 (e.g., communicatively coupled wired or wirelessly to computing device 602 via wired interface(s) 680 and/or wireless modem(s) 660). Further input devices 630 (not shown) can include a Natural User Interface (NUI), a pointing device (computer mouse), a joystick, a video game controller, a scanner, a touch pad, a stylus pen, a voice recognition system to receive voice input, a gesture recognition system to receive gesture input, or the like. Other possible output devices (not shown) can include piezoelectric or other haptic output devices. Some devices can serve more than one input/output function. For instance, display 654 may display information, as well as operating as touch screen 632 by receiving user commands and/or other information (e.g., by touch, finger gestures, virtual keyboard, etc.) as a user interface. Any number of each type of input device(s) 630 and output device(s) 650 may be present, including multiple microphones 634, multiple cameras 636, multiple speakers 652, and/or multiple displays 654.

One or more wireless modems 660 can be coupled to antenna(s) (not shown) of computing device 602 and can support two-way communications between processor 610 and devices external to computing device 602 through network 604, as would be understood to persons skilled in the relevant art(s). Wireless modem 660 is shown generically and can include a cellular modem 666 for communicating with one or more cellular networks, such as a GSM network for data and voice communications within a single cellular network, between cellular networks, or between the mobile device and a public switched telephone network (PSTN). Wireless modem 660 may also or alternatively include other radio-based modem types, such as a Bluetooth modem 664 (also referred to as a “Bluetooth device”) and/or Wi-Fi modem 662 (also referred to as an “wireless adaptor”). Wi-Fi modem 662 is configured to communicate with an access point or other remote Wi-Fi-capable device according to one or more of the wireless network protocols based on the IEEE (Institute of Electrical and Electronics Engineers) 802.11 family of standards, commonly used for local area networking of devices and Internet access. Bluetooth modem 664 is configured to communicate with another Bluetooth-capable device according to the Bluetooth short-range wireless technology standard(s) such as IEEE 802.15.1 and/or managed by the Bluetooth Special Interest Group (SIG).

Computing device 602 can further include power supply 682, LI receiver 684, accelerometer 686, and/or one or more wired interfaces 680. Example wired interfaces 680 include a USB port, IEEE 1394 (Fire Wire) port, a RS-232 port, an HDMI (High-Definition Multimedia Interface) port (e.g., for connection to an external display), a DisplayPort port (e.g., for connection to an external display), an audio port, and/or an Ethernet port, the purposes and functions of each of which are well known to persons skilled in the relevant art(s). Wired interface(s) 680 of computing device 602 provide for wired connections between computing device 602 and network 604, or between computing device 602 and one or more devices/peripherals when such devices/peripherals are external to computing device 602 (e.g., a pointing device, display 654, speaker 652, camera 636, physical keyboard 638, etc.). Power supply 682 is configured to supply power to each of the components of computing device 602 and may receive power from a battery internal to computing device 602, and/or from a power cord plugged into a power port of computing device 602 (e.g., a USB port, an A/C power port). LI receiver 684 may be used for location determination of computing device 602 and may include a satellite navigation receiver such as a Global Positioning System (GPS) receiver or may include other type of location determiner configured to determine location of computing device 602 based on received information (e.g., using cell tower triangulation, etc.). Accelerometer 686 may be present to determine an orientation of computing device 602.

Note that the illustrated components of computing device 602 are not required or all-inclusive, and fewer or greater numbers of components may be present as would be recognized by one skilled in the art. For example, computing device 602 may also include one or more of a gyroscope, barometer, proximity sensor, ambient light sensor, digital compass, etc. Processor 610 and memory 656 may be co-located in a same semiconductor device package, such as being included together in an integrated circuit chip, FPGA, or system-on-chip (SOC), optionally along with further components of computing device 602.

In embodiments, computing device 602 is configured to implement any of the above-described features of flowcharts herein. Computer program logic for performing any of the operations, steps, and/or functions described herein may be stored in storage 620 and executed by processor 610.

In some embodiments, server infrastructure 670 may be present in computing environment 600 and may be communicatively coupled with computing device 602 via network 604. Server infrastructure 670, when present, may be a network-accessible server set (e.g., a cloud-based environment or platform). As shown in FIG. 6, server infrastructure 670 includes clusters 672. Each of clusters 672 may comprise a group of one or more compute nodes and/or a group of one or more storage nodes. For example, as shown in FIG. 6, cluster 672 includes nodes 674. Each of nodes 674 are accessible via network 604 (e.g., in a “cloud-based” embodiment) to build, deploy, and manage applications and services. Any of nodes 674 may be a storage node that comprises a plurality of physical storage disks, SSDs, and/or other physical storage devices that are accessible via network 604 and are configured to store data associated with the applications and services managed by nodes 674. For example, as shown in FIG. 6, nodes 674 may store application data 678.

Each of nodes 674 may, as a compute node, comprise one or more server computers, server systems, and/or computing devices. For instance, a node 674 may include one or more of the components of computing device 602 disclosed herein. Each of nodes 674 may be configured to execute one or more software applications (or “applications”) and/or services and/or manage hardware resources (e.g., processors, memory, etc.), which may be utilized by users (e.g., customers) of the network-accessible server set. For example, as shown in FIG. 6, nodes 674 may operate application programs 676. In an implementation, a node of nodes 674 may operate or comprise one or more virtual machines, with each virtual machine emulating a system architecture (e.g., an operating system), in an isolated manner, upon which applications such as application programs 676 may be executed.

In an embodiment, one or more of clusters 672 may be co-located (e.g., housed in one or more nearby buildings with associated components such as backup power supplies, redundant data communications, environmental controls, etc.) to form a datacenter, or may be arranged in other manners. Accordingly, in an embodiment, one or more of clusters 672 may be a datacenter in a distributed collection of datacenters. In embodiments, exemplary computing environment 600 comprises part of a cloud-based platform.

In an embodiment, computing device 602 may access application programs 676 for execution in any manner, such as by a client application and/or a browser at computing device 602.

For purposes of network (e.g., cloud) backup and data security, computing device 602 may additionally and/or alternatively synchronize copies of application programs 614 and/or application data 616 to be stored at network-based server infrastructure 670 as application programs 676 and/or application data 678. For instance, operating system 612 and/or application programs 614 may include a file hosting service client configured to synchronize applications and/or data stored in storage 620 at network-based server infrastructure 670.

In some embodiments, on-premises servers 692 may be present in computing environment 600 and may be communicatively coupled with computing device 602 via network 604. On-premises servers 692, when present, are hosted within an organization's infrastructure and, in many cases, physically onsite of a facility of that organization. On-premises servers 692 are controlled, administered, and maintained by IT (Information Technology) personnel of the organization or an IT partner to the organization. Application data 698 may be shared by on-premises servers 692 between computing devices of the organization, including computing device 602 (when part of an organization) through a local network of the organization, and/or through further networks accessible to the organization (including the Internet). Furthermore, on-premises servers 692 may serve applications such as application programs 696 to the computing devices of the organization, including computing device 602. Accordingly, on-premises servers 692 may include storage 694 (which includes one or more physical storage devices such as storage disks and/or SSDs) for storage of application programs 696 and application data 698 and may include one or more processors for execution of application programs 696. Still further, computing device 602 may be configured to synchronize copies of application programs 614 and/or application data 616 for backup storage at on-premises servers 692 as application programs 696 and/or application data 698.

Embodiments described herein may be implemented in one or more of computing device 602, network-based server infrastructure 670, and on-premises servers 692. For example, in some embodiments, computing device 602 may be used to implement systems, clients, or devices, or components/subcomponents thereof, disclosed elsewhere herein. In other embodiments, a combination of computing device 602, network-based server infrastructure 670, and/or on-premises servers 692 may be used to implement the systems, clients, or devices, or components/subcomponents thereof, disclosed elsewhere herein.

As used herein, the terms “computer program medium,” “computer-readable medium,” and “computer-readable storage medium,” etc., are used to refer to physical hardware media. Examples of such physical hardware media include any hard disk, optical disk, SSD, other physical hardware media such as RAMs, ROMs, flash memory, digital video disks, zip disks, MEMs (microelectronic machine) memory, nanotechnology-based storage devices, and further types of physical/tangible hardware storage media of storage 620. Such computer-readable media and/or storage media are distinguished from and non-overlapping with communication media and propagating signals (do not include communication media and propagating signals). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared, and other wireless media, as well as wired media. Embodiments are also directed to such communication media that are separate and non-overlapping with embodiments directed to computer-readable storage media.

As noted above, computer programs and modules (including application programs 614) may be stored in storage 620. Such computer programs may also be received via wired interface(s) 680 and/or wireless modem(s) 660 over network 604. Such computer programs, when executed or loaded by an application, enable computing device 602 to implement features of embodiments discussed herein. Accordingly, such computer programs represent controllers of the computing device 602.

Embodiments are also directed to computer program products comprising computer code or instructions stored on any computer-readable medium or computer-readable storage medium. Such computer program products include the physical storage of storage 620 as well as further physical storage types.

### V. Additional Example Embodiments

Systems, methods, and instrumentalities are described herein related to performing large tensor tiling (LTT). Embodiments described herein enable large tensor tiling (LTT). LTT divides a large tensor (e.g., a tensor that may have an unsupported size) into tiles (e.g., having supported tensor size(s)) using overlapping or crossover tiles with duplicated or otherwise reused edges. A tensor may be processed (e.g., convolved) by processing the tiles. The output of each processed tile is stored, for example, in a systolic array considering the tile's placement in the large tensor. The output of all processed tiles is identical to the output of processing the large tensor. For instance, in the example of four tiles, the tiles are each treated as if ¼×¼×C (height H by width W by number of channels C). Note that in data memory, the data itself may be sorted differently, with this different sorting taken into consideration in the output handler such that the output of the processed tiles is identical to that for the large tensor processed individually. Tiles may be processed by reusing data overlapping boundaries shared with other tiles. In some examples, overlapping data may be reused (e.g., written once) or partly reused (e.g., written twice). Tiling large tensors with boundary duplication supports dynamic adaptation to a wide variety of tensor sizes, avoids re-reading duplicated data, and avoids reorganizing hardware for large tiles, which reduces power consumption and area, reduces complexity, and increases processing efficiency.

In aspects, a computing system may include a neural processing unit (NPU) that includes a systolic array and a data router. The systolic array includes a scalable array of interconnected processing elements (PEs). In an embodiment, each PE has an associated PE data memory configured to store at least a portion of an input tensor, while in another embodiment, each cluster of PEs had PE data memory shared by the PEs to store the portion of the input tensor. The data router is configured to perform tensor tiling of an input tensor by determining or receiving an indication how to split the input tensor into a plurality of tiles based on the array of interconnected PEs and dimensions of the input tensor; and splitting the input tensor into the plurality of tiles, including a first tile and a second tile overlapping a shared edge, by routing the input tensor data to the PE data memories that store the plurality of tiles. Tiles may be processed (e.g., convolved) using data overlapping tile boundaries. Depending on the configuration of the array of interconnected PEs and/or routing/storage of tile data, the overlapping data at shared tile boundaries may be stored once and reused or may be duplicated, e.g., stored in multiple PE data memories. For example, a 16×16×4 tensor may be split into four 9×9×4 overlapping tensors. The overlapping nature of the tensors may result in reuse or duplication of stored tensor tile data.

In aspects, an input handler may be configured to provide the indication to the data router. Each PE may be associated with a PE convolution engine configured to perform a convolution on a respective portion of a tile stored in the associated PE data memory. A systolic controller may be configured to control each of the PE convolution engines to perform the convolution on the respective portions of one or more tiles stored in the associated PE data memory based on the split and routing. The PE convolution engine may be configured to perform the convolution on respective portions of multiple tiles stored in the associated PE data memory by reusing data in the associated PE data memory overlapping the shared edge, and/or with the use of padding of zeros or duplicated data. In some examples, the input tensor may be routed to the PE data memories that store the plurality of tiles, including the first and second tiles, with data overlapping the shared edge written once or duplicated in a first PE data memory associated with a first PE and in a second PE data memory associated with a second PE. In some examples, the tiles may be transposed in the PE data memories by storing tile rows as columns in the PE data memories. Each PE may be associated with a PE weight (e.g., convolution filter) memory. Weights may be routed to the PE weight memories based on the routing of the input tensor to store the plurality of tiles in the PE data memories. The data router may be a hardware-implemented algorithm. The systolic array may include a scalable array of interconnected PEs.

In an example, a system (e.g., an NPU) may comprise a systolic array comprising an array (e.g., an N×M matrix) of interconnected processing elements (PEs). Each PE may be associated with a PE data memory configured to store at least a portion of a tensor. The system may comprise a data router (e.g., data splitter) configured to perform tensor tiling of an input tensor, the data router configured to: determine a split of the input tensor into a plurality of tiles based on the array of interconnected PEs and dimensions of the input tensor; and split the input tensor into the plurality of tiles, including a first tile and a second tile overlapping a shared edge, by routing the input tensor data to the PE data memories that store the plurality of tiles.

In examples, the system may (e.g., further) comprise an input handler configured to provide an indication of the determined split to the data router (e.g., in a tensor descriptor associated with the input tensor).

In examples, each PE may be associated with a PE convolution engine configured to perform a convolution on a respective portion of a tile stored in the associated PE data memory.

In examples, the system may (e.g., further) comprise a systolic controller configured to control (e.g., by configuring and/or instructing) each of the PE convolution engines to perform the convolution on the respective portion of the tile stored in the associated PE data memory based on the split (e.g., dynamically adjust engine processing based on the split).

In examples, the PE convolution engine may be configured to perform the convolution on respective portions of multiple tiles stored in the associated PE data memory by reusing data in the associated PE data memory that overlaps the shared edge.

In examples, the data router may be configured to route the input tensor to the PE data memories that store the plurality of tiles with data along the shared edge duplicated in a first PE data memory associated with a first PE and in a second PE data memory associated with a second PE. For example, overlapping data in a first dimension (e.g., width or height) may be duplicated while overlapping data in a second dimension may not be duplicated (e.g., reused during operations since it is written continuously in same PE data memory).

In examples, the data router may be (e.g., further) configured to transpose the plurality of tiles in the PE data memories by storing tile rows as columns in the PE data memories.

In examples, each PE may be (e.g., further) associated with a PE weight (e.g., convolution filter) memory. The data router may be (e.g., further) configured to route weights to the PE weight memories based on the routing of the input tensor to store the plurality of tiles in the PE data memories.

In examples, the data router may comprise a hardware-implemented algorithm.

In examples, the systolic array may comprise a scalable array of interconnected PEs.

In another example, a method may comprise performing, by a data router, a tensor tiling of an input tensor comprising: determining a split of the input tensor into a plurality of tiles based on dimensions of the input tensor and a systolic array comprising an array of interconnected processing elements (PEs), e.g., where each PE may be associated with a PE data memory configured to store at least a portion of the input tensor; and splitting the input tensor into the plurality of tiles, including a first tile and a second tile overlapping a shared edge, by routing the input tensor to the PE data memories that store the plurality of tiles.

In examples, the method may (e.g., further) comprise performing a convolution on the input tensor by performing, by a PE convolution engine associated with each PE, a convolution on respective portions of the input tiles stored in the associated PE data memory.

In examples, the PE convolution engine may be configured to perform the convolution on respective portions of multiple tiles stored in the associated PE data memory by reusing data in the associated PE data memory that overlaps the shared edge. Note that the data reuse can be logic efficient as data can be read continuous from the last writing of the previous tile.

In examples, the routing of the input tensor may comprise routing the input tensor to the PE data memories that store the plurality of tiles with data along the shared edge duplicated in a first PE data memory associated with a first PE and in a second PE data memory associated with a second PE.

In examples, the routing of the input tensor may comprise transposing the plurality of tiles in the PE data memories by storing tile rows as columns in the PE data memories.

In examples, the method may (e.g., further) comprise routing weights to PE weight memories associated with each PE based on the routing of the input tensor to store the plurality of tiles in the PE data memories.

In another example, a neural processing unit (NPU) may comprise a systolic array comprising an array of interconnected processing elements (PEs), each PE associated with a PE data memory configured to store at least a portion of a tensor; and a data router configured to perform tensor tiling of an input tensor, the data router configured to: determine a split of the input tensor into a plurality of tiles based on the array of interconnected PEs and dimensions of the input tensor; and split the input tensor into the plurality of tiles, including a first tile and a second tile overlapping a shared edge, by routing the input tensor data to the PE data memories that store the plurality of tiles.

In examples, the data router may be (e.g., further) configured to route weights to the PE weight memories based on the routing of the input tensor to store the plurality of tiles in the PE data memories. Each PE may be associated with a PE convolution engine configured to perform a convolution on the input tensor by performing a convolution on respective portions of the input tiles stored in the associated PE data memory with the weights stored in the associated PE weight memories.

In examples, the PE convolution engine may be configured to perform the convolution on respective portions of multiple tiles stored in the associated PE data memory by reusing data in the associated PE data memory that overlaps the shared edge.

In examples, the routing of the input tensor may comprise routing the input tensor to the PE data memories that store the plurality of tiles with data along the shared edge duplicated in a first PE data memory associated with a first PE and in a second PE data memory associated with a second PE.

### VI. Conclusion

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

In the discussion, unless otherwise stated, adjectives modifying a condition or relationship characteristic of a feature or features of an implementation of the disclosure, should be understood to mean that the condition or characteristic is defined to within tolerances that are acceptable for operation of the implementation for an application for which it is intended. Furthermore, if the performance of an operation is described herein as being “in response to” one or more factors, it is to be understood that the one or more factors may be regarded as a sole contributing factor for causing the operation to occur or a contributing factor along with one or more additional factors for causing the operation to occur, and that the operation may occur at any time upon or after establishment of the one or more factors. Still further, where “based on” is used to indicate an effect being a result of an indicated cause, it is to be understood that the effect is not required to only result from the indicated cause, but that any number of possible additional causes may also contribute to the effect. Thus, as used herein, the term “based on” should be understood to be equivalent to the term “based at least on.”

Numerous example embodiments have been described above. Any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

Furthermore, example embodiments have been described above with respect to one or more running examples. Such running examples describe one or more particular implementations of the example embodiments; however, embodiments described herein are not limited to these particular implementations.

Moreover, according to the described embodiments and techniques, any components of systems, computing devices, servers, device management services, virtual machine provisioners, applications, and/or data stores and their functions may be caused to be activated for operation/performance thereof based on other operations, functions, actions, and/or the like, including initialization, completion, and/or performance of the operations, functions, actions, and/or the like.

In some example embodiments, one or more of the operations of the flowcharts described herein may not be performed. Moreover, operations in addition to or in lieu of the operations of the flowcharts described herein may be performed. Further, in some example embodiments, one or more of the operations of the flowcharts described herein may be performed out of order, in an alternate sequence, or partially (e.g., or completely) concurrently with each other or with other operations.

The embodiments described herein and/or any further systems, sub-systems, devices and/or components disclosed herein may be implemented in hardware (e.g., hardware logic/electrical circuitry), or any combination of hardware with software (e.g., computer program code configured to be executed in one or more processors or processing devices) and/or firmware.

While various embodiments have been described above, it should be understood that they have been presented by way of example only, and not limitation. It will be apparent to persons skilled in the relevant art that various changes in form and detail can be made therein without departing from the spirit and scope of the embodiments. Thus, the breadth and scope of the embodiments should not be limited by any of the above-described example embodiments, but should be defined only in accordance with the following claims and their equivalents.

What is claimed is:

1. A computing system, comprising:
a systolic array comprising an array of interconnected processing elements (PEs), each PE associated with a PE data memory configured to store at least a portion of a tensor; and
a data router configured to perform tensor tiling of an input tensor, the data router configured to:
determine a split of the input tensor into a plurality of tiles based on the array of interconnected PEs and dimensions of the input tensor; and
split the input tensor into the plurality of tiles, including a first tile and a second tile overlapping a shared edge, by routing the input tensor data to the PE data memories that store the plurality of tiles.

2. The computing system of claim 1, further comprising:
an input handler configured to provide an indication of the determined split to the data router.

3. The computing system of claim 1, wherein each PE is associated with a PE convolution engine configured to perform a convolution on a respective portion of a tile stored in the associated PE data memory.

4. The computing system of claim 3, further comprising
a systolic controller configured to control each of the PE convolution engines to perform the convolution on the respective portion of the tile stored in the associated PE data memory based on the split.

5. The computing system of claim 3, wherein the PE convolution engine is configured to perform the convolution on respective portions of multiple tiles stored in the associated PE data memory by reusing data in the associated PE data memory that overlaps the shared edge.

6. The computing system of claim 1, wherein the data router is configured to route the input tensor to the PE data memories that store the plurality of tiles with data along the shared edge duplicated in a first PE data memory associated with a first PE and in a second PE data memory associated with a second PE.

7. The computing system of claim 1, wherein the data router is further configured to transpose the plurality of tiles in the PE data memories by storing tile rows as columns in the PE data memories.

8. The computing system of claim 1, wherein each PE is further associated with a PE weight memory and wherein the data router is further configured to route weights to the PE weight memories based on the routing of the input tensor to store the plurality of tiles in the PE data memories.

9. The computing system of claim 1, wherein the data router comprises a hardware-implemented algorithm.

10. The computing system of claim 1, wherein the systolic array comprises a scalable array of interconnected PEs.

11. A method, comprising:
performing, by a data router, a tensor tiling of an input tensor comprising:
determining a split of the input tensor into a plurality of tiles based on dimensions of the input tensor and a systolic array comprising an array of interconnected processing elements (PEs), each PE associated with a PE data memory configured to store at least a portion of the input tensor; and
splitting the input tensor into the plurality of tiles, including a first tile and a second tile overlapping a shared edge, by routing the input tensor to the PE data memories that store the plurality of tiles.

12. The method of claim 11, further comprising:
performing a convolution on the input tensor by performing, by a PE convolution engine associated with each PE, a convolution on respective portions of the input tiles stored in the associated PE data memory.

13. The method of claim 12, wherein the PE convolution engine is configured to perform the convolution on respective portions of multiple tiles stored in the associated PE data memory by reusing data in the associated PE data memory that overlaps the shared edge.

14. The method of claim 11, wherein the routing of the input tensor comprises routing the input tensor to the PE data memories that store the plurality of tiles with data along the shared edge duplicated in a first PE data memory associated with a first PE and in a second PE data memory associated with a second PE.

15. The method of claim 11, wherein the routing of the input tensor comprises transposing the plurality of tiles in the PE data memories by storing tile rows as columns in the PE data memories.

16. The method of claim 11, further comprising:
routing weights to PE weight memories associated with each PE based on the routing of the input tensor to store the plurality of tiles in the PE data memories.

17. A neural processing unit (NPU), comprising:
a systolic array comprising an array of interconnected processing elements (PEs), each PE associated with a PE data memory configured to store at least a portion of a tensor; and
a data router configured to perform tensor tiling of an input tensor, the data router configured to:
determine a split of the input tensor into a plurality of tiles based on the array of interconnected PEs and dimensions of the input tensor; and
split the input tensor into the plurality of tiles, including a first tile and a second tile overlapping a shared edge, by routing the input tensor data to the PE data memories that store the plurality of tiles.

18. The NPU of claim 17,
wherein the data router is further configured to route weights to the PE weight memories based on the routing of the input tensor to store the plurality of tiles in the PE data memories; and
wherein each PE is associated with a PE convolution engine configured to perform a convolution on the input tensor by performing a convolution on respective portions of the input tiles stored in the associated PE data memory with the weights stored in the associated PE weight memories.

19. The NPU of claim 18, wherein the PE convolution engine is configured to perform the convolution on respective portions of multiple tiles stored in the associated PE data memory by reusing data in the associated PE data memory that overlaps the shared edge.

20. The NPU of claim 17, wherein the routing of the input tensor comprises routing the input tensor to the PE data memories that store the plurality of tiles with data along the shared edge duplicated in a first PE data memory associated with a first PE and in a second PE data memory associated with a second PE.
